(19) United States
(12) Patent Application Publication
(10) Pub. No.: US 2012/0087662 A1
(43) Pub. Date: Apr. 12, 2012

(54) PASSIVE OPTICAL NETWORK AND SUBSCRIBER LINE TERMINAL

(75) Inventors: Katsuyoshi Suzuki, Yokohama (JP); Masao Niibe, Fujisawa (JP); Shinya Fujioka, Kawasaki (JP); Masahiko Mizutani, Fujisawa (JP)

(73) Assignee: Hitachi, Ltd

(21) Appl. No.: 13/240,634

(22) Filed: Sep. 22, 2011

(30) Foreign Application Priority Data
Oct. 6, 2010 (JP) 2010-226551

(51) Int. Cl. H04J 14/00

(52) U.S. Cl. 398/66

(57) ABSTRACT

The OLT manages information of optical intensity and communication bit rate receivable by each ONU, and transmits a signal at suitable optical intensity and a bit rate. The OLT decides a signal transmission plan for each ONU according to a status of accumulated information waiting to be transmitted in the OLT's own device buffer, and inserts the signal transmission plan in a header or payload of a downlink frame, thereby notifying the ONUs of the information prior to transmitting accumulated information (primary signal). The ONU recognizes the signal transmission plan of the OLT according to the time information in a downlink intensity map, receives only a signal having the optical intensity and bit rate suitable for the ONU's own device, and blocks other signals.

### CLAIM OF PRIORITY

The present application claims priority from Japanese patent application serial no. 2010-226551, filed on Oct. 6, 2010, the content of which is hereby incorporated by reference into this application.

### BACKGROUND OF THE INVENTION

The present invention relates to a configuration and an operating method of an optical communication system where more than one subscriber unit shares an optical transmission line, and the present invention also relates to system extensions, such as an extension of transmission distance and an increase in subscribership in the optical communications system.

Demands for broadband communications are growing. In the field of user-oriented access line, this growth of demands is expediting progress to a large-capacity access line using optical fibers, which substitutes for an access technique on the basis of the telephone infrastructure such as the Digital Subscriber Line (DSL). Now, as a service of the access line, a Passive Optical Network (PON) system (hereinafter, referred to simply as “PON”, “Optical Passive Network system”, or “Passive Optical Network system”) is extensively used, from the standpoint of line construction cost and maintenance cost. As a representative example of the PON, there is standardization in the International Telecommunication Union Telecommunication Standardization Sector (ITU-T) (see ITU-T Recommendation G. 984.3). Nations in the world are engaged in introducing Gigabit PON (GPON) into the access network starting from around the year of 2006.

The PON is a system for conducting transmit and receive, by splitting and multiplexing optical signals from a terminal on the side of station building (hereinafter referred to as “OLT”: Optical Line Terminal) to a subscriber unit (hereinafter, referred to as “ONU”: Optical Network Unit), by using optical fibers and optical splitters. Due to a limitation such as attenuated amount of optical signals after passing through the optical fiber and due to the number of optical branches in the optical splitter, there has been a certain marginal distance as a communication distance between the OLT and the ONU. Specifically, for the case of the GPON, it is configured such that the maximum length of communication section is 20 km, and the maximum number of branching (the number of ONUs being connectable with the OLT) is 64.

More and more home subscribers (communication network users) are gaining access to the Internet to establish communications for collecting information and for social life. Accordingly, there is a growing demand to upgrade the communication network, more particularly, to expand the range of services provided by the access network which connects the subscribers to the communication network. In other words, carriers who provide the communication network are coming under pressure to boost capital, in order to increase the number of the user lines for each station, along with the increase of the number of users who use the access lines.

In order to increase the number of users, some methods are conceivable as follows: additionally introducing the PON itself used for the access network, i.e., adding the OLT, or expanding the number of user lines held in each PON system, i.e., expanding the number of ONUs being accommodated.

Generally, the PON has a configuration that the OLT conducts overall control of complicated systems, such as bandwidth control and management of the accommodated ONUs. Therefore, the OLT is far more expensive than the ONU. In addition, if new optical fibers are constructed, carriers may suffer from large expenses due to the cost. Considering the situation above, it is a preferred solution to expand the number of accommodated ONUs per OLT. On the other hand, in order to expand a range of services provided by the access network, a next-generation PON is now being studied, as means for conducting transmission at a bit rate higher than conventional transmission, which is referred to as “10 Gigabit PON (10 GPON)” and “10 Gigabit Ethernet PON (10 GEPON))”, respectively in the ITU-T and in the Institute of Electrical and Electronics Engineers (IEEE). Such high bit-rate transmission as described above may cause more significant impact due to attenuation and dispersion of optical signals which pass through the optical fibers, compared to the transmission at a conventional bit rate. Therefore, in order to establish a system having the communication distance equivalent to the existing PON, it is required to prepare an optical receiver with a wide dynamic range, a high-performance optical fiber, and a function of dispersion compensation. Though it is possible to expand the number of accommodated users by using a higher bit rate, there is a problem that this may result in an increase of developing cost.

As one method for extending the PON section, an optical amplifier is applied to an optical laser for transmitting a downlink signal from the OLT, thereby allowing the optical power to be intensified. It is further possible to install an optical amplifier (optical signal relay) referred to as Reach Extender (RE) in the PON section, thereby enabling extension of the communication distance.

Introduction of the optical amplifier allows the communication distance to be extended more than the conventional PON. Therefore, the subscriber ONU which exists in a remote place is allowed to be accommodated in the same OLT, facilitating enlargement of accommodation by the OLT. In other words, efficiency of the OLT to accommodate the ONUs is enhanced. This may allow larger coverage of distribution of the ONUs connected to the OLT which is installed in the station building, relative to what it is now.

On the other hand, such expansion of the ONU distribution produces a considerable disparity in signal intensity of the downlink signals outputted from the OLT directed to the ONU, between the closest ONU and the farthest ONU, and this causes a problem that such disparity goes beyond a tolerance level of light receiving sensitivity of the optical receiver in the ONU. This problem occurs because there is an ever-larger difference in the optical fiber distance which optical signals go through until they reach individual ONUs. Furthermore, in the case of the PON having the configuration including multiple splitters, the downlink signals received by the ONUs vary in optical intensity, depending on the number of splitters that the optical signals pass through until they reach individual ONUs.

In general, it is demanded that all the ONUs are provided with the same performance from the viewpoint of cost for introducing the PON. Assuming this condition as a prerequisite, enlargement of distance disparity between the OLT and the ONU may require a more dynamic range for the receivers on the side of the ONUs, than those in the conventional PON. However, it is difficult to drastically enhance the performance of the optical receiver within a short period of time. Therefore, there is a possibility that a signal receivable by the ONU close to the OLT cannot be identified by the ONU at a remote place, and on the other hand, when an optical signal supposed to be transmitted to the ONU at a remote place is received by the ONU located nearby, the receiver of the nearby ONU may fail to operate properly. In order to avoid this problem, it is also conceivable to employ a method that inserts an optical signal relay in the optical fiber, upstream from the remote place ONU. However, this may cause extra device installation cost and maintenance cost.

Moreover, it will be demanded in the near future to additionally introduce a high bit rate transmission technique targeting 10 Gbits/s, as a next-generation PON. This new PON and the Gigabit-rate PON are required to coexist, and this establishes a system configuration where the communication bit rate varies within the PON section, even though the distance between the OLT and the ONU is identical to that of the existing PON. Under the circumstances, variance in optical transmission characteristics caused by a bit rate difference, even if the distance is the same, may result in a non-negligible difference in the optical intensity received by the ONU side.

### SUMMARY OF THE INVENTION

The present invention provides a method for transmitting a downlink signal from the OLT to the ONU, and a method for processing a downlink signal inside the OLT. According to these methods, even in the case where the communication distance between the OLT and ONU is extended and the accommodated ONU numbers are increased, by introducing an optical amplifier into the PON, it is possible to prevent a breakdown of the optical receiver due to over-intensity of light receiving and the like, and a receiving failure due to optical signal deterioration, within the ONUs each having equivalent performance, and further incorporate PONS having variable bit rates within the same network, thereby allowing all the ONUs to receive the downlink signals from the OLT. Preferably, the present invention is also to provide a method for implementing the OLT which is able to prevent the occurrence of the problems as described above, without drastically changing the functions provided in the conventional PON.

In order to solve the problems above, the optical communication system according to the present invention adjusts optical intensity to transmit a signal from a parent station (OLT), in such a manner that the optical intensity at the receiving time becomes suitable for each child station (ONU). The OLT manages information such as the optical intensity and a bit rate of each ONU, collected while ranging process, and gives an advance notice as to a signal transmission plan including optical intensity information, prior to transmitting downlink signals to each ONU.

In order to generate the downlink signal transmission plan, the OLT monitors a receiving status of the downlink signals received from the upstream network (data accumulation status in the signal receiving buffer), and generates based on the accumulation status in the buffer, the downlink signal transmission plan for indicating a series of downlink signal frames and descriptions of the frame transmission.

In the process for generating the downlink signal transmission plan being notified prior to primary signals, the OLT monitors the buffer within its own device, and decides the signal transmission plan directed to each ONU, based on a result of the monitoring.

According to the present invention, it is possible to expand the difference in distance from the OLT to the ONU in the existing optical communication system, and enhance accommodation efficiency of the OLT, further allowing the PON being different in bit rate to be incorporated into the same network of the existing PON, thereby reducing the cost associated with reinforcement, maintenance, and management of the optical access network.

In the downlink signal transmission plan for transmitting the signal from the OLT to each ONU, the result of the buffer monitoring within the OLT's own device is reflected. Therefore, it is possible to efficiently perform mapping data to be transmitted by the downlink signals on downlink signal frames, according to a waiting data amount. With this configuration, efficiency of bandwidth utilization in the downlink communication is improved.

In addition, each ONU blocks the signals other than the signals directed to its own group, thereby reducing driving time of an internal circuit, and producing an effect of reducing consumption power of the ONU.

### BRIEF DESCRIPTION OF THE DRAWINGS

FIG. 1 is a block diagram showing a PON system;

FIG. 2 is a signal block diagram for explaining time division multiplexing transmission of downlink signals in the PON system;

FIG. 3 is a block diagram showing the OLT;

FIG. 4 is a block diagram showing a downlink frame processor and a PON controller of the OLT;

FIG. 5 is a block diagram showing the ONU;

FIG. 6 is a block diagram showing a downlink frame processor, a PON controller, and an uplink frame processor of the ONU;

FIG. 7 is a sequence diagram for explaining a ranging operation performed between the OLT 10 and ONU group 20A;

FIG. 8 is a sequence diagram for explaining a ranging operation performed between the OLT 10 and ONU group 20D;

FIG. 9 is a sequence diagram for explaining a ranging operation performed between the OLT 10 and ONU group 20B;

FIG. 10 is a sequence diagram for explaining a ranging operation performed between the OLT 10 and ONU group 20C;

FIG. 11 is a flowchart for explaining the ranging processing of the OLT 10;

FIG. 12 illustrates an ONU table generated by the OLT for the ranging processing;

FIG. 13 illustrates a downlink intensity map;

FIG. 14 is a flowchart for explaining the downlink frame processing in the optical controller 1090 of the OLT 10;

FIG. 15A illustrates a configuration of an optical amplification factor database;

FIG. 15B illustrates another configuration of the optical amplification factor database;

FIG. 16 is a flowchart showing downlink frame processing by the transmission plan decision part 12108 in the OLT 10, when the downlink frame processing is performed;

FIGS. 17A to 17C-C are signal block diagrams for explaining an arrangement of the downlink intensity map;

FIGS. 18A and 18B are timing charts of the downlink variable intensity signals in the PON system;

FIG. 19A illustrates a queue length of a signal directed to each ONU group, the signal being acquired by the OLT 10 from the buffer;

FIG. 19B is a signal block diagram when the OLT transmits a downlink signal;

FIG. 20 illustrates various information used in the downlink intensity map; and

FIG. 21 is a sequence diagram for explaining a procedure when a new ONU is registered in the PON system 1.

### DESCRIPTION OF THE PREFERRED EMBODIMENT

Hereinafter, a detailed explanation will be made as to a preferred embodiment, by using an example with reference to the accompanying drawings. Portions being substantially the same are labeled the same, and explanations will not be repeated. In the following example, a configuration and an operation of the PON will be explained, by using the configuration and the operation of the GPON as stipulated by the ITU-T standard G. 984.3. However, the present invention is not limited to the GPON.

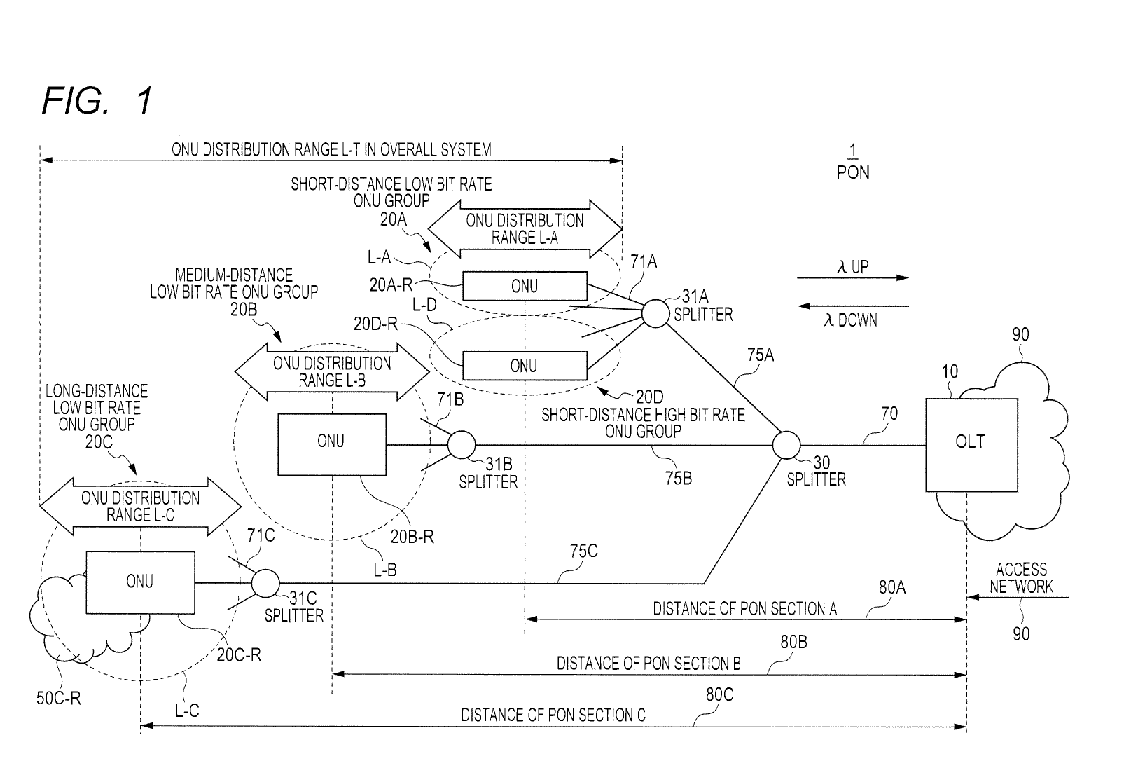

With reference to FIG. 1, a configuration of the PON system will be explained. In FIG. 1, a PON 1 incorporates an OLT 10, a concentrated fiber 70, a splitter 30, three first branch fibers 75A, 75B, and 75C, three splitters 31A, 31B, and 31C, multiple second branch fibers 71A, 71B, and 71C, and multiple ONUS.

In a conventional PON represented by a GPON, a distribution range of communication distance of subscriber units ONUS, which are included in each PON system, i.e., a difference of distance between the ONU at the closest position to the OLT 10 and the ONU at the farthest position therefrom, has been restricted within 20 km. Accordingly, the coverage of issued optical intensity and the coverage of light receiving sensitivity of an optical module are defined in the range where the optical communication is available with the OLT 10 (the range where communication is possible between the OLT and all the ONUs by optical signals at a certain intensity), without considering distance distribution between ONUs.

In order to reutilize such existing equipment and optical devices to the maximum extent, a first feature of the present example is to group the ONUs constituting the PON 1 to establish connection, in such a manner that the ONUs are located at the positions within a distance of 20 km from the OLT 10. Specifically, the second-stage splitters 31A, 31B, and 31C are provided under the splitter 30, for bundling the ONUs 20, group by group, and the ONUs are connected to these second-stage splitters 31A to 31C. As a matter of course, it is also possible to treat individual ONUs as being independent (i.e., it is assumed that one ONU exists in one group). Hereinafter, a configuration will be explained, where such ONU group as described above is employed. It is to be noted here that the number of ONUs within the group is optional.

In the PON, once the optical fibers are constructed, such optical fibers will not be renewed frequently, unless there occurs an accident or the like which needs such renewal. Also as for the locations for installing the ONUs, once they are installed, a setting status of the PON will not be changed, unless there are particular circumstances such as moving and urban redevelopment. Therefore, this system is stable and it is extremely rare that any change occurs in communication quality. By utilizing the characteristics above, the splitters 31A, 31B, and 31C are installed according to the positions of the ONUs (and according to the distance from the OLT 10), thereby establishing a configuration where one or multiple ONUs are bundled. Therefore, in FIG. 1, the second splitters 31A to 31C are installed in addition to the first splitter 30, and optical fibers which connect the individual ONUs and the splitters 31A to 31C are assumed as 75A, 75B, and 75C, respectively. There is also shown a configuration where the ONUs under the second splitters are categorized according to the communication distance and the bit rate in association with the OLT, and ONU groups 20A, 20B, 20C, and 20D are obtained. Here, each of the ONU-ONU range differences L-A, L- B, L-C, and L-D in the individual ONU groups is assumed as within 20 km. The range difference when all the ONUs 20 are distributed (a maximum range difference of the communication distance between the ONU 20 and the OLT 10) is assumed as ONU distribution range L-T. In other words, this indicates that the ONUs, which are arranged in a distributed manner in a range exceeding 20 km which is a definition of existing PON in association with one OLT 10, are accommodated in the group. In addition, the communication distances of the PON sections from the OLT 10 to the ONU groups 20A (20D), 20B, and 20 are represented as A, B, and C, and the PON sections are represented as 80A, 80B, and 80C.

The PON 1 incorporates the OLT 10, and ONUs categorized in a multiple number of groups ONU 20A-1 to 20A-nA, 20B-1 to 20B-nB, 20C-1 to 20C-nC, and 20D-1 to 20D-nD (hereinafter, when all the ONUs are represented collectively, these are described as “ONU 20” or “ONU 20A-1 to 20D-nD”. Here nA, nB, nC, and nD are natural numbers for identifying ONUs included in each group. FIG. 1 shows ONU 20A-R, 20B-R, 20C-R, and 20D-R as a representative ONU of each group. The present system further incorporates the concentrated optical fiber 70, the optical splitter 30, the multiple first branch optical fibers 75A to 75C, and in addition, branch splitters 31A to 31C for bundling each ONU group, the second branch fibers 71A to 71C for establishing connection between the ONUs 20 and the splitters 31A to 31C.

The PON 1 is a system having in the OLT 10 an optical amplifier not illustrated, and the ONUS 20 (20A-1 to 20D-nD) are respectively connected to subscriber networks (or terminals such as PCs and telephones; in FIG. 1, only the subscriber network 50C-R connected to the ONU 20C-R is illustrated as a representative example) 50, and the PON 1 further connecting the OLT 10 with the access network 90 being an upstream communication network.

Here, for the case where the optical amplifier is introduced into the PON section, instead of the optical amplifier inside the OLT 10, it is possible that the optical amplifier is introduced for each optical fiber of branch network (in FIG. 1, shown as the optical fibers 75B and 75C) and the communication carrier makes adjustments so that the optical amplifier allows a signal at appropriate optical intensity to reach the ONU as a destination of signal transmission (in FIG. 1, shown as ONU groups 20B and 20C). With the configuration above, no problem occurs, no matter how distant the ONU is located from the OLT. However, there is another problem that the cost associated with the installation and maintenance of the optical amplifiers may be increased. Therefore, in practical application, the introduction of the optical amplifier should be limited to the minimum, i.e., only to a fundamental network (in FIG. 1, the optical fiber 70). The position for arranging the optical amplifier does not have any impact on the essence of the present example, but in the following description, an explanation will be made assuming that the optical amplifier is arranged on the optical fiber 70, which minimizes the maintenance cost of the optical amplifier.

The OLT 10 carries out transmitting and receiving information via the access network 90 with an upstream communication network. The OLT 10 is a device for transferring information further to the ONU 20, thereby transmitting and receiving information signals. It is to be noted that, in many cases, the access network 90 employs a packet communication network incorporating IP routers and Ethernet (registered trademark) switches. However, the access network 90 may be a communication network other than the one described above. Generally, the ONU 20 is installed in a user house or at a company site, and it is configured in such a manner as connected to a LAN or a subscriber network 50 which is an appropriate network. An IP phone, a telephone providing an existing telephone service, and an information terminal such as a PC and/or a mobile terminal are connected to each subscriber network 50. In the PON sections 80 (80A to 80C), communications are established via optical signals, between the OLT 10 and each of the ONUs 20 (20A-1 to 20D-nD). It is to be noted here that the wavelength of the optical signal used in the PON is configured such that uplink λup and downlink λdown are made different in wavelength, so as to avoid interference between signals in the optical fibers 70, 75 (75A to 75C), 71 (71A to 71C), and in the splitters 30 and 31 (31A to 31C).

Downlink signals issued from the OLT 10 to the ONU 20 are amplified or subjected to intensity adjustment by the intensity controller (not illustrated) incorporating the optical amplifier and the like, branched by the splitter 30 and the splitters 31A to 31C, and then, reach the ONUs 20A-1 to 20D-nD constituting the PON 1. The downlink signals from the OLT 10 are outputted by using a frame (hereinafter referred to as “basic downlink frame”) which is used for communication in the PON sections 80 (80A to 80C). This basic downlink frame accommodates a frame referred to as GPON Encapsulation Method (GEM) frame. The GEM frame is made up of a header and a payload, and each header has an identifier (sometimes referred to as “Port-ID”) inserted for identifying the ONU 20 which is the destination of individual GEM frame. The ONU 20 extracts the header of the GEM frame, and performs frame processing when the destination Port-ID indicates the ONU 20 itself. The ONU 20 discards the frame when the destination of the frame indicates not the ONU 20 itself but a different ONU 20.

As for uplink communication from each of the ONUs 20 to the OLT 10, electric signals are outputted from all the ONUs 20, by using optical signals having the same wave length λup. For the uplink signals, a variable-length frame is used, which is made up of a header and a payload as to each ONU in the same manner as the downlink signal, and each uplink frame includes the GEM frame. The ONU 20 outputs uplink signals at the transmission timing being shifted, so as to avoid collision and interference of individual uplink signals on the concentrated optical fiber 70, in order to allow the OLT 10 to identify the GEM frame from each of the ONUs 20. These signals are subjected to time division multiplexing, respectively on the concentrated optical fibers 71 (71A to 71C), 75 (75A to 75C) and 70, and then, reach the OLT 10. Specific steps are described as follows:

(1) A distance from the OLT 10 to each of the ONUs 20A-1 to 20D-nD is measured in the process of ranging, and then a delay amount of signals is adjusted;

(2) According to a directive from the OLT 10, each of the ONUs 20A-1 to 20D-nD is made to inform an amount of data waiting to be transmitted;

(3) According to Dynamic Bandwidth Assignment (DBA) function (a function for dynamically assigning to the ONU 20, a communication bandwidth (time slot) used for uplink signals, referred to as “dynamic bandwidth assignment”), the OLT 10 provides a directive regarding the uplink signal transmission timing from each of the ONUs 20-1 to 20-n and uplink communication data amount available for outputting, based on the information above;

(4) When each ONU 20 transmits uplink communication data at the timing indicated by the OLT 10, these signals are subjected to time division multiplexing on the concentrated optical fibers 71, 75, and 70, and reach the OLT 10; and

(5) Since the OLT 10 knows the timing as to which the OLT 10 indicated for each of the ONUs 20, the OLT 10 identifies a signal of each of the ONUs 20 from the multiplexed signals, and performs processing on the received frame.

An explanation will be made as to a system operation example for performing the aforementioned uplink communication. Firstly, when the PON 1 is started up, the OLT 10 measures individual Round Trip Delay (RTD) respectively to the ONUs 20 during the ranging process in starting the ONUs individually, and on the basis of a result of the measurement, a value of Equalization Delay (EqD) is determined. The value of EqD is stored in a ranging management database 1061 of the OLT 10. The ranging method stipulated in ITU-T standard G. 984.3 may be employed for the ranging described above. It is to be noted that the EqD is set, so that response time lengths from the individual ONUS 20 to the OLT 10 become identical within the system, similar to the EqD of an existing PON.

The ranging management database 1061 of the OLT 10 holds the EqD information and the RTD of the PON sections 80. This configuration allows the OLT 10 to receive the uplink signals from the ONUS 20 properly, when the OLT 10 performs the bandwidth assignment to each of the ONUS 20, and thereafter receives the uplink signals from the associating ONU 20.

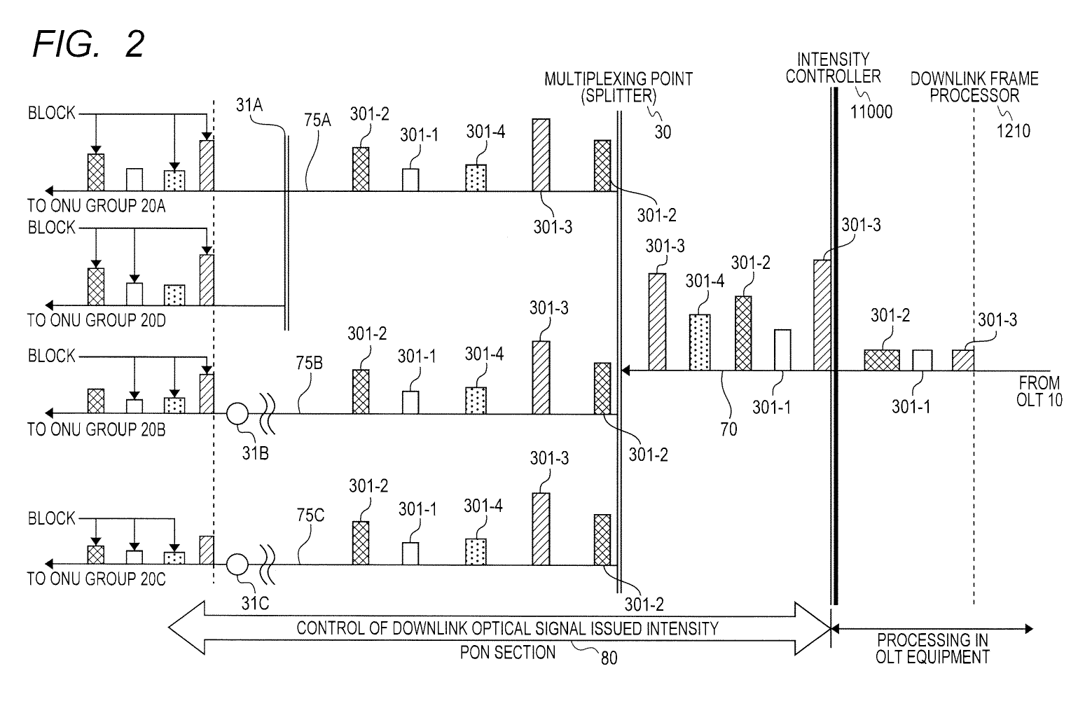

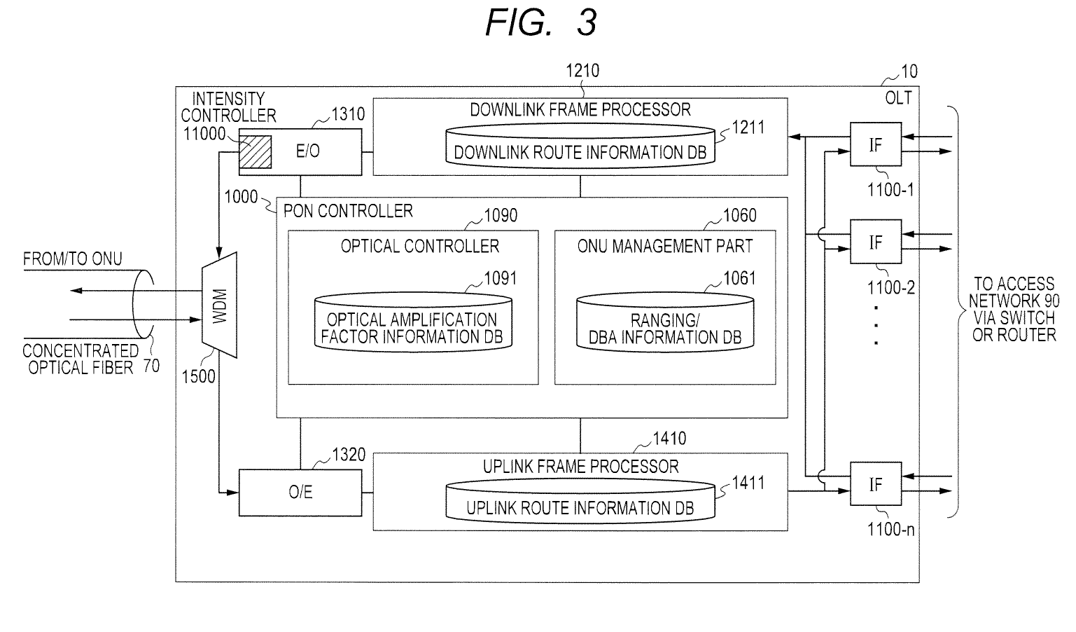

With reference to FIG. 2, a time division multiplexing transmission of downlink signals in the PON will be explained. In FIG. 2, the OLT 10 encapsulates signals from the access network 90, received via the Service Network Interface (SNI), into a GEM frame in a downlink frame processor (FIG. 3; 1210), and further binds one or multiple GEM frames to generate a downlink communication frame every 125 microseconds. Thereafter, the OLT 10 converts the generated downlink frame into optical signals in the O/E processor 1310, further converts them to have optical intensity defined in the optical controller (FIG. 3; 1090) with respect to each ONU 20 being a destination of individual GEM frame, and then outputs the signals to the concentrated optical fibers 70. FIG. 2 illustrates a situation where a downlink signal is transmitted and multiplexed from the OLT 10 side to the ONU 20 side, showing the case where the intensity of optical signals is gradually reduced while passing through the optical fiber (in addition, deterioration of S/N ratio and lowering of signal decision level due to wavelength dispersion effect).

The optical signals outputted to one concentrated optical fiber 70 pass through the splitter 30 are branched to each of the first branch optical fibers 75A to 75C, further branched by the splitters 31A to 31C, and then distributed to the second branch optical fibers 71A to 71C. The optical intensity is reduced when passing through the splitters 30 and 31. However, taking this reduction into account, the signals are transmitted from the OLT 10 at the intensity necessary for reaching the ONU 20 being a target. Each ONU 20 receives the downlink signals via the branch optical fibers 71A to 71C. In FIG. 2, the optical signals 301-1 to 301-4 represent transmitted position and transmitted data size of the downlink frames transmitted to each of the ONUs 20A-1 to 20D-nD. In relation to FIG. 1, it is possible to assume that the downlink signal 301-1 is directed to the ONU 20A-R, the downlink signal 301-2 is directed to the ONU 20B-R, the downlink signal 301-3 is directed to the ONU 20C-R, and the downlink signal 301-4 is directed to the ONU 20D-R.

FIG. 2 further illustrates that there is variation in intensity of the optical signals that the OLT 10 transmits to the ONU 20. In FIG. 2, the received signal directed to the ONU group 20C shows the highest optical intensity, the signal directed to the ONU group 20B shows the second, and the signals directed to the ONU 20D and the ONU 20A show the level of the optical intensity in descending order. The relationship as to the intensity of optical signals is maintained also on the concentrated optical fiber 70 after passing through the splitter 30, and information is transferred in the same relationship. It is to be noted that the processing from the downlink frame processor 1210 to an intensity controller 11000 is performed inside the OLT 10, and the optical signals in the PON sections 80 indicate the state (timing and intensity) of the optical signals in each of the sections.

Operations when the downlink optical signals reach the destinations are as follows. The ONU group 20A receives the optical signal 301-1. The ONU group 20A is a group which is the closest to the OLT 10, and other signals have optical intensity higher than that of the signals directed to the ONU group 20A. Consequently, by using the intensity controller 2311 of the ONU 20, those signals (signals 301-2, 301-3, and 301-4 in the figure) are blocked. A detailed explanation will be made later as to the way how each ONU blocks the signals.

The ONU group 20D receives the optical signal 301-4. The ONU group 20D is located at the same distance as the ONU group 20A, with respect to the OLT 10, but the signal bit rate is higher than the ONU group 20A. According to optical transmission characteristics, a higher bit rate signal is attenuated at a distance shorter than a low bit rate signal, and therefore, the high bit rate signal is outputted at higher optical intensity than the signal for the ONU group 20A which is located at the same distance. The ONU group 20D receives only the signal 301-4 directed to its own group, and other signals (301-1, 301-2, and 301-3) are blocked by using the intensity controller 2311. The signal 301-1 has optical intensity receivable also by the ONU group 20D. In the present example, however, all signals other than those directed to one's own group are blocked, in order to reduce unnecessary drive of an internal circuit of the ONU. It is further possible not only to block those signals but also to discard them in the ONU.

Similarly, the ONU group 20B receives only the signal 301-2 and blocks the other signals (301-1, 301-3, and 301-4). The ONU group 20C receives only the signal 301-3 and blocks the other signals (301-1, 301-2, and 301-4).

With reference to FIG. 3, a configuration of the OLT will be explained. In FIG. 3, the OLT 10 incorporates IFs 1100, the downlink frame processor 1210, an Electrical/Optical converter (E/O) 1310, a PON controller 1000, an Optical/Electrical converter (O/E) 1320, an uplink frame processor 1410, and a Wavelength Division Multiplexer (WDM) 1500. The downlink frame processor 1210 holds a downlink route information database 1211. The Electrical/Optical converter (E/O) 1310 incorporates the intensity controller 11000. The PON controller 1000 incorporates an optical controller 1090 and an ONU management part 1060. The uplink frame processor 1410 holds an uplink route information database 1411. The optical controller 1090 holds an optical amplification factor information database 1091. The ONU management part 1060 holds a ranging/DBA information database 1061. The IFs 1100 are connected to the access network 90 via a switch or a router. The WDM 1500 is connected to the ONU 20 via the concentrated optical fiber 70.

Downlink signals are inputted from the access network 90 into the IFs 1100-1 to 1100-n, referred to as the Service Network Interface (SNI). It is to be noted that, in many cases, a packet communication network is employed as the access network 90, and Ethernet interface of 10/100 Mbits/s or 1 Gbits/s is used as the IF. A received signal (hereinafter, also referred to as “data” or “packet”) is transferred to the downlink frame processor 1210. The downlink frame processor 1210 analyzes header information of the packet. Specifically, the downlink frame processor 1210 decides the ONU 20 to which the received packet to be transferred as a destination, based on flow identification information including destination information, transmission source information, and route information included in the header of the packet. The downlink frame processor 1210 conducts conversion and provision of the header information of the received packet as appropriate. It is to be noted that the downlink frame processor 1210 is provided with the downlink route information database 1211 for fixing the processing including decision of the destination, and conversion or provision of the header information, and performs the processing above with reference to the database 1211, using one or multiple parameters as a key, which is contained as the header information of the received packet.

The downlink frame processor 1210 is also provided with a frame generation function which modifies the received packet to a frame format used for transmission in the PON section 80, according to the descriptions of the header processing, which are fixed inside the downlink frame processor 1210. Specific processing is as follows, when a received Ethernet packet is transmitted to the PON section 80 of the GPON:

(1) Header information of the Ethernet packet is extracted;

(2) The downlink route information database 1211 in the downlink frame processor 1210 is searched using the header information as a key, thereby deciding ULAN tag processing (conversion, deletion, transparency, provision, and the like) of the received packet and a destination of the received packet;

(3) A GEM header is generated, including a Port-ID set as a corresponding transfer destination ONU by the frame generation function; and

(4) This GEM header is provided to the received packet, and the Ethernet packet is encapsulated as a GEM frame.

The GEM frame obtained by encapsulating the Ethernet packet is read from the downlink frame processor 1210. The E/O processor 1310 converts thus readout electric signal to an optical signal. The E/O processor 1310 transmits the optical signal to the ONU 20, via the Wavelength Division Multiplexer (WDM) 1500 and the concentrated optical fiber 70. On this occasion, the intensity controller 11000 provided in the E/O processor 1310 transmits the optical signals each having different optical intensity, depending on the ONU groups to which the transmission target ONU 20 belongs, as a destination of the frame. This intensity controller 11000 is implemented by an optical amplifier and an amplification factor setting circuit of the optical amplifier (not illustrated). The amplification factor setting circuit is controlled according to a directive from the optical controller 1090. The optical controller 1090 refers to the destination of the downlink frame, and sets the amplification factor of the frame, according to the amplification factor obtained from the optical amplification information database 1091 which is associated with the destination. The optical amplification factor information is set based on the ranging information held by the ONU management part 1060 (the ranging information being communication distance information of the PON section, calculated based on the RTD).

The PON controller 1000 is a part that performs control such as setting and management of each ONU 20, and further performs control of the entire PON 1 including signal transmission control in both directions; uplink and downlink. In the present example, the OLT 10 performs intensity control of the downlink optical signals. Therefore, the present example has a configuration that the OLT 10 includes the optical controller 1090 as a function of the PON controller. Information held in the ranging/DBA information database 1061 of the PON controller includes an EqD setting value with respect to each individual ONU 20. This information corresponds to the transmission distance (required transmission time /response delay time) from the OLT 10 to each ONU, and it is stored in the ranging/DBA information database 1061 to be used for DBA processing during the PON operation.

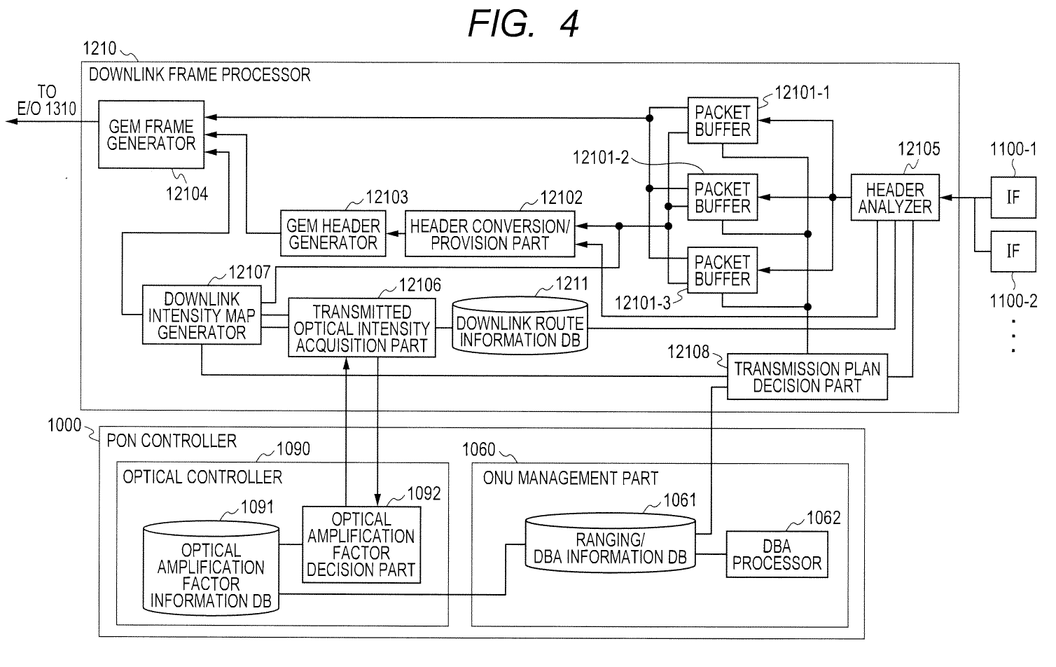

With reference to FIG. 4, a detailed configuration of the downlink frame processor 1210 and the PON controller 1000 of the OLT 10 will be explained. In FIG. 4, the downlink frame processor 1210 incorporates a header analyzer 12105, multiple packet buffers 12101, a header conversion/provision part 12102, a GEM header generator 12103, a GEM frame generator 12104, a transmission plan decision part 12108, a transmitted optical intensity acquisition part 12106, and a downlink intensity map generator 12107. In addition, the downlink frame processor 1210 holds the downlink route information database 1211. It is to be noted that the number of the packet buffers is three, but it is not limited to three.

The PON controller 1000 is made up of the optical controller 1090 and the ONU management part 1060. The optical controller 1090 incorporates an optical amplification factor decision part 1092 and holds the optical amplification factor information database 1091. The ONU management part 1060 incorporates a DBA processor 1062, and holds the ranging/DBA information database 1061.

Processing of the downlink packet transferred to the downlink frame processor 1210 follows the procedure described below. The downlink packet received by the interfaces 1100-1 and 1100-2 are subjected to header analysis by the header analyzer 12105, then stored in the packet buffers 12101, and transferred to the E/O converter 1310 via the GEM frame generator 12104. Within a series of this flow described above, before notifying the GEM frame generator 12104 of the packet information, the downlink frame processor 1210 (1) performs analysis of the header information and decides the transfer direction, (2) decides a transmission plan of the downlink packet, and (3) decides optical intensity of the downlink packet transmission and generates the downlink intensity map.

In the processing (1), the header analyzer 12105 decides whether or not the header conversion is necessary and a method taken for the conversion (provision, deletion, transparency, or transformation) based on the flow identification information including the destination information, transmission source information, and route information which are contained in the header part. This decision is made by referring to a part of (e.g., destination information) or all of the flow identification information of the packet, and matching the information with the route table held in the downlink route information database 1211. Referring to the descriptions of the header conversion obtained here, the GEM header generator 12103 generates pertinent GEM frame header information, and transfers the information to the GEM frame generator 12104. After the processing in the header analyzer 12105 ends, the packet is stored in any of the packet buffers on the subsequent stage. In the present example, however, the packet buffer as storage is changed depending on the destination ONU group of the packet. The transmission plan decision part 12108 gives a directive as to which buffer the packet is to be stored.

In the processing (2), the transmission plan decision part 12108 sequentially monitors the packet buffers 12101-1 to 12101-3. The transmission plan decision part 12108 decides a signal transmission plan for each ONU group based on a result of the monitoring. The transmission plan decision part 12108 notifies the downlink intensity map generator 12107 of the decided signal transmission plan and the plan is used for generating the downlink intensity map. A description of the signal transmission plan and a method for deciding the plan will be explained later in detail.

In the processing (3), the downlink intensity map generator 12107 acquires the header part of the packet from the packet buffers 12101-1 to 12101-3, and based on the header information, makes a request of transmitted optical intensity information from the transmitted optical intensity acquisition part 12106, and a request of a signal transmission plan from the transmission plan decision part 12108. The downlink intensity map generator 12107 generates a downlink intensity map based on the transmitted optical intensity information and the signal transmission plan acquired.

The transmitted optical intensity acquisition part 12106 requests the optical amplification factor decision part 1092 provided in the PON controller 1000 to designate an appropriate optical intensity for transmitting the downlink packet. The optical amplification factor decision part 1092 refers to the optical amplification factor information database 1091, acquires an optical amplification factor associated with the destination ONU of the packet, and notifies the transmitted optical intensity acquisition part 12106 of the downlink frame processor 1210, of the optical amplification factor. It is to be noted that the optical amplification factor information database 1091 is provided with a function for calculating optical intensity necessary for the communication with each individual ONU, based on the communication distance measurement using the ranging process that is carried out when the ONUS are started. The DBA processor 1062 included in the ONU management part 1060 is a functional block for calculating for each individual ONU, the timing when an uplink signal (packet) is outputted. This is similar to the DBA which assigns a bandwidth for uplink signals, as used in a conventional PON, and a bandwidth assignment status calculated here is held in the ranging/DBA information database 1061 until the uplink frame that has once been assigned is completely received.

The GEM frame generator 12104 combines the GEM frame header information, with the data (frame payload) stored in the packet buffer 12101, generates a downlink GEM frame, and further combines the downlink GEM frames to generate a downlink frame every 125 microseconds. A specific frame configuration will be described later.

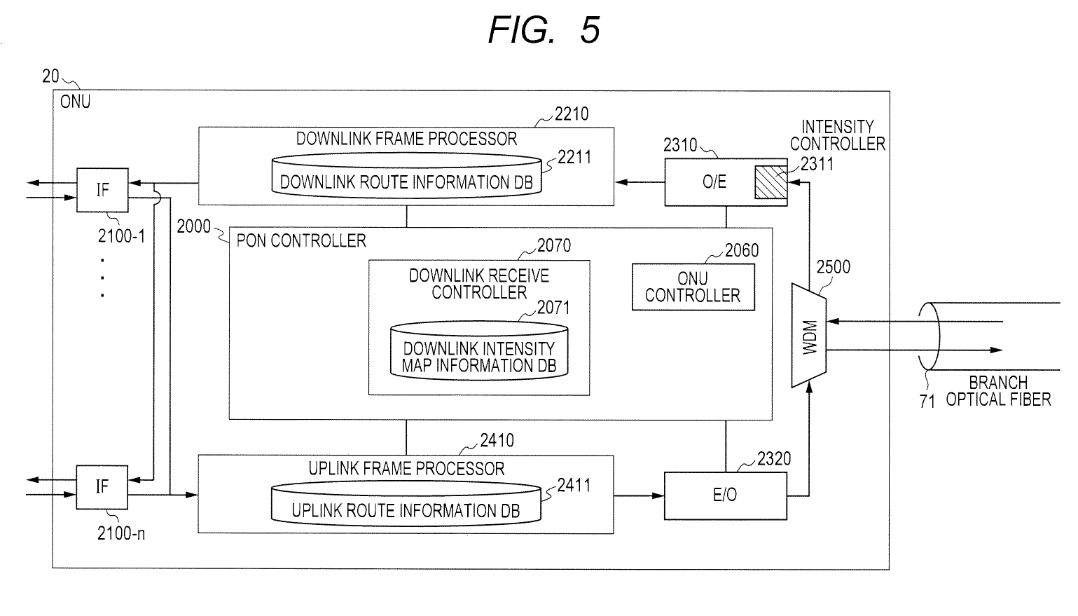

With reference to FIG. 5, a configuration of the ONU will be explained. In FIG. 5, the ONU 20 incorporates a WDM 2500, an O/E processor 2310, a downlink frame processor 2210, n IFs 2100, a PON controller 2000, an uplink frame processor 2410, and an E/O processor 2320. The O/E processor 2310 includes an intensity controller 2311. The downlink frame processor 2210 holds a downlink route information database 2211. The PON controller 2000 is made up of a downlink receive controller 2070 and an

ONU controller 2060. The uplink frame processor 2410 holds an uplink route information database 2411. The downlink receive controller 2070 holds a downlink intensity map information database 2071. The WDM 2500 is connected to the OLT 10 via the second branch fiber 71. The IFs 2100 are connected to a subscriber network 50.

Uplink signals to the PON, from a terminal (not illustrated) accommodated in the ONU 20 are inputted from the subscriber network 50 to the IFs 2100-1 to 2100-n referred to as User Network Interface (UNI). It is to be noted that in many cases, a LAN or a packet network is employed also for the subscriber network 50, and Ethernet interface of 10/100 Mbits/s or 1 Gbits/s is used as the IF.

The configuration and operation for processing the downlink signals and uplink signals in the ONU 20 are almost the same as the configuration and the operation of the uplink signals and the downlink signals in the OLT 10, which have been explained with reference to FIG. 3 and FIG. 4, respectively. As for the downlink signal, the downlink frame processor 2210 provided with the downlink route information database 2211 for fixing processing including the destination decision based on the result of the header analysis, and conversion and provision of the header information, converts the GEM frame received from the PON section 80 into an Ethernet packet, and outputs the Ethernet packet to a terminal of the ONU 20. As for the uplink signal, the uplink frame processor 2410 provided with the uplink route information database 2411 converts the Ethernet packet received from the terminal into the GEM frame, and outputs the GEM frame to the OLT 10.

The intensity controller 2311 monitors the intensity of the optical signal received from the OLT 10 via the optical fiber 70 and the branch fiber 71, and adjusts the intensity to be suitable for the optical receiver which constitutes the O/E processor 2310 of the ONU 20. The intensity controller 2311 blocks high-intensity optical signals to prevent the optical receiver of the O/E processor 2310 from breaking down. The intensity controller 2311 operates according to a directive from the ONU controller 2060. The ONU controller 2060 stores in the downlink intensity map information database 2071, received time information (downlink intensity map) of the downlink signal, the information being obtained as a result of the frame processing in the downlink frame processor 2210. On the basis of the information, the ONU controller 2060 controls the intensity controller 2311 so that receiving of the downlink signals is enabled, while downlink signals are transmitted, at appropriate optical intensity and a communication bit rate to be received by the ONU group to which the its own device belongs, and light is blocked for the signals other than the above downlink signals. An operation of the intensity controller 2311 will be explained later in detail.

The ONU controller 2060 is a functional block used for setting parameters in the case where the ONU 20 is started up and for managing the communication status, according to a directive from the OLT 10, and this functional block includes analysis of received frame, control of maintenance management information of the device, and determination whether or not it is required to establish communication (make a response) to the OLT 10.

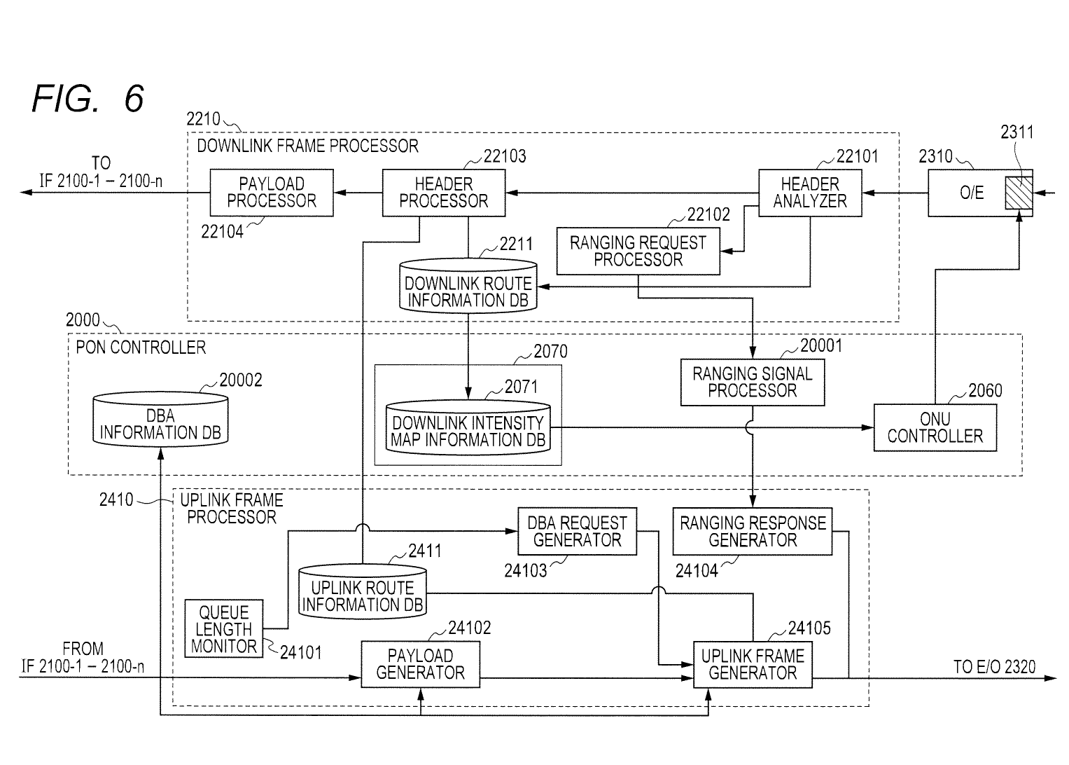

With reference to FIG. 6, an explanation will be made in detail as to the downlink frame processor, the PON controller, and the uplink frame processor of the ONU 20. In FIG. 6, the downlink frame processor 2210 incorporates a header analyzer 22101, a ranging request processor 22102, a header processor 22103, and a payload processor 22104. The downlink frame processor 2210 holds a downlink route information database 2211.

The PON controller 2000 is provided with a ranging signal processor 20001, in addition to the ONU controller 2060 and the downlink receive controller 2070. The PON controller 2000 holds a DBA information database 20002 in addition to the downlink intensity map information database 2071.

The uplink frame processor 2410 incorporates a queue length monitor 24101, a payload generator 24102, a DBA request generator 24103, a ranging response generator 24104, and an uplink frame generator 24105. The uplink frame processor 2410 holds an uplink route information database 2411.

The header analyzer 22101 of the downlink frame processor 2210 checks the downlink signal received via the WDM 2500, (1) as to whether the frame is directed to its own device, and if it is directed to its own device, (2) as to the header information of the frame. Here, the information included in the downlink frame is put into two large categories. One category relates to a signal for controlling the PON section and it is to be terminated in the ONU 20, and the other category relates to a principal signal frame such as user data, and it is to be transferred to equipment connected to the IFs 2100-1 to 2100-n.

A representative example of the former operation includes signal transmitting and receiving at the time of the ranging process. Upon detecting that the information indicates a ranging request from the OLT 10 directed to the ONU 20 as its own device, the header analyzer 22101 transfers the information to the ranging request processor 22102. The ranging request processor 22102 records the time of day when the ranging request is received, further generates an internal signal (response request notice) for notifying that the ranging request has been received, and transfers the internal signal together with the received time of day, to the ranging signal processor 20001. It is defined that information as to the received clock time is returned to the OLT, approximately 35 microseconds after receiving the ranging request.

A representative example of the latter is a user data transferring process in the downlink direction. The payload part of the PON downlink frame includes one or more user data items in the form of GEM frame. The header analyzer 22101 refers to the header information of each individual GEM frame, and performs processing of the GEM frame when there exists in the GEM header an identifier (hereinafter, referred to as “Port-ID”) indicating that the GEM frame is directed to its own device (ONU 20). Specifically, the header analyzer changes the data format so as to transfer the signal received as the GEM frame to the equipment connected to the IFs 2100-1 to 2100-n. The header analyzer 22101 refers to the address field (Ethernet destination address and IP destination address as representative examples) indicating each destination of each data item in the GEM header, and decides the IF 2100 for outputting each data item (specifically, an IF physical address or an IF identifier used inside the device (implementation-dependent)). Upon deciding this IF, the downlink route information database 2211 is referred to. It is further necessary to change or add the header information of the user data frame when a signal is transferred from the downlink frame processor 2210 to the IFs 2100. This corresponds to the change of VLAN tag value or inserting of VLAN tag that is given to the Ethernet frame. Therefore, the downlink route information database 2211 holds information indicating association between the frame destination information and the IF identifier as a transmission destination, together with a header information conversion rule for establishing the association. According to the downlink route information database 2211, the header processor 22103 performs header processing which is required along with the system settings as described above, and builds a header format of a downlink frame suitable for external equipment. Thereafter, the payload processor 22104 establishes a downlink frame format in combination with the user data included in the payload part of the frame, and transfers the frame to the IFs 2100-1 to 2100-n.

The PON controller 2000 incorporates the ranging signal processor 20001. Upon receiving a response request notice from the ranging request processor, the ranging signal processor 20001 decides a time for outputting a ranging response based on the time of the ranging request receipt included in the notice (in practice, the time can be calculated by using in-device clock frequency), and outputs a directive for generating and outputting the ranging response to the ranging response generator 24104. The normal ranging process is performed only when the ONU 20 is started up. However, in the case where a communication disturbance is detected such as abnormality in uplink signal synchronization during operation, the ranging processing may be performed again. On this occasion, the ranging signal processor 20001 of the PON controller 2000 notifies the uplink frame processor that outputting of the uplink user data frame is stopped when the ranging response is transmitted. It is to be noted that FIG. 6 illustrates processing in a normal operation, and a flow of control signals in the case of communication disturbance is not illustrated.

The uplink frame processor 2410 is provided with the ranging response generator 24104. The ranging response generator 24104 generates and outputs a ranging response according to a directive from the ranging signal processor 20001. On this occasion, the ranging response generator 24104 performs timing control in such a manner that the ranging signal processor starts outputting toward the E/O converter 2320 at the time designated by the ranging signal processor.

Next, with reference to FIG. 6, processing in the case where the ONU 20 receives a downlink signal will be explained. In FIG. 6, for the optical receiver used in the ONU 20, an S/N ratio level which allows signal identification and an upper limit value of optical intensity which allows signal receipt without crashing the device, are already determined. The downlink signal received normally in the O/E part 2310 and in the header analyzer 22101 is held in the frame buffer (not illustrated) provided in the downlink frame processor 2210 when the signal does not represent a ranging request, and the header analyzer 2210 analyzes the header information of the signal. In this header analyzing process, if a downlink intensity map directed to its own device (ONU 20) is detected, the downlink intensity map information database 2071 is notified of this information, and this database 2071 holds this downlink intensity map. When a decision is made whether or not it is directed to its own device, the downlink route information database 2211 is referred to. Since its specific operation is the same as already described above, it will not be explained. The downlink intensity map includes descriptions as to the timing when the ONU 20 is to receive the downlink signal, and the timing when to block the downlink signal (represented by the time of day or a clock frequency (byte count)). The ONU controller 2060 refers to the downlink intensity map information database 2071, thereby giving a directive as to the timing for receiving the downlink signal, to the intensity controller 2311 provided in the O/E part 2310. According to the directive, the intensity controller 2311 blocks the downlink optical signal or opens the light receiving part. With the configuration above, in the ONU 20, it is possible to prevent a failure of an optical device in the O/E part 2310 and an issuance of communication abnormality alert which is unnecessary (in the case of receiving a signal at a low S/N ratio in the frame directed to the ONU other than its own device).

Next, a process of uplink signal in the ONU 20 will be explained. The signals received in the IFs 2100-1 to 2100-n are once accumulated within the ONU 20, and thereafter, the signals are transferred to the OLT according to the uplink frame transmission timing directed by the OLT. A procedure for configuring the uplink signal is divided into the header information process and the payload information process, similarly to the analysis of the downlink signal. The information inputted as the uplink signal is once accumulated in the frame buffer (not illustrated) provided in the uplink frame processor. As for the payload part, the payload generator 24102 subjects the payload part to transparency process, division process, or combining process, to configure a payload of the GEM frame. The processing at this stage depends on the uplink signal outputting bandwidth (convertible to byte count), as to which the OLT gives a directive.

On the other hand, as to the header information, there are two-stage processing to be performed. The first stage is a process for configuring a GEM header of the uplink signal received from the IF 2100. As an identifier of the ONU 20, a Port-ID assigned to the ONU 20 in advance is inserted in to the GEM header. When this Port-ID is determined, the uplink route information database 2411 is referred to. In addition, when an uplink frame is configured, the ONU 20 notifies the OLT 10 of an uplink bandwidth request, referred to as a DBA report. This information is stored within the header of the uplink frame. Specifically, the uplink bandwidth request is to notify the OLT 10 of the data accumulation amount of a queue made up of the uplink signals which are waiting to be transmitted in the ONU 20. This information allows receiving a permission of transmission from the OLT 10 in accordance with the data volume. The uplink frame generator 24105 combines the uplink signal header information including the uplink bandwidth request, with the payload generated by the payload generator 24102, and consequently completing the uplink frame. Thereafter, the uplink frame is outputted via the E/O part 2320 at the timing according to the permission of uplink signal transmission from the OLT 10. It is to be noted that the permission of uplink signal transmission from the OLT 10 is held in the DBA information database 20002 which is provided in the ONU 20.

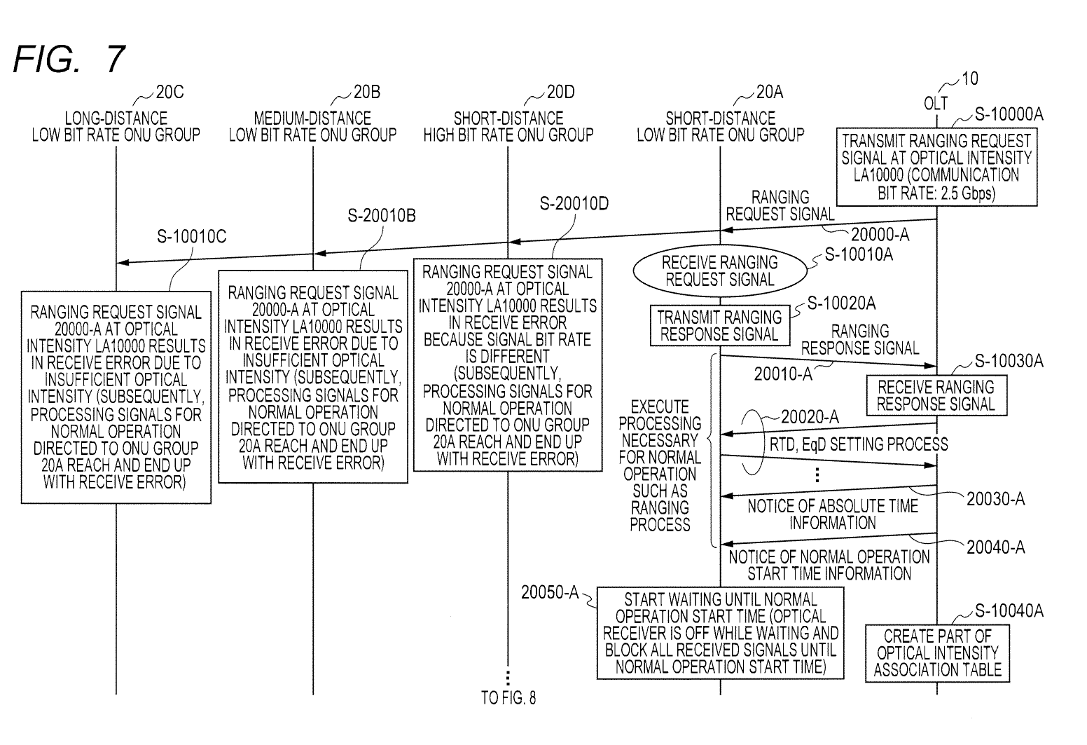

With reference to FIG. 7 to FIG. 10, an explanation will be made as to a ranging operation which is performed between the OLT and each ONU when the PON system is started up. It is assumed that in the PON system of the present example, the OLT 10 is associated with two types of communication bit rate; 2.5 Gbits/s being the communication bit rate of the GPON communication, and 10 Gbits/s being the communication bit rate of the next-generation standard communication. There is further assumed a situation where as for the ONUS under the OLT, ONUS compliant with the communication bit rate of 2.5 Gbits/s and ONUS compliant with the communication bit rate of 10 Gbits/s exist in a mixed manner. Here, it is described that the next-generation standard PON is associated with the communication bit rate of 10 Gbits/s. However, it does not mean that the communication bit rate of the next-generation standard PON is limited to 10 Gbits/s. The explanation above is made just for describing a model that PON systems having various communication bit rates are accommodated in a mixed manner.

As described in ITU-T Recommendation G. 984.3, an explanation will be made, assuming a startup process from the state where the OLT 10 does not know, at the initial stage of operation, the distance up to the ONU 20 or the communication bit rate supported by the ONU 20.

With reference to FIG. 7, the ranging operation will be explained, which is conducted between the OLT and each of the ONUs belonging to the ONU group 20A, at the time when the PON system is started up. In FIG. 7, after the OLT 10 is started, it transmits a ranging request signal 20000-A to each of the ONUs. On this occasion, the OLT 10 does not have information as to the arrangement of each of the ONUs or the communication bit rate thereof. The OLT 10 firstly transmits, to each of the ONUs, the ranging request signal 20000-A at the minimum optical intensity (this intensity is assumed as “optical intensity LA10000”) and at the communication bit rate of 2.5 Gbits/s (S-10000A). On this occasion, due to the influence of the distance and transmission loss between the OLT-ONU, any of the ONUs may properly receive the ranging request signal 20000-A transmitted at the aforementioned minimum optical intensity LA10000. On the other hand, any of the ONUs may fail to receive the ranging request signal 20000-A, due to insufficient level of receiver sensitivity of the O/E 2310 mounted on each ONU or due to a difference in communication bit rate. Here, it is assumed that the ONUs in the ONU group 20A are capable of receiving the ranging request signal 20000-A (S-10010A), and the ONUs in the remaining ONU group 20D, the ONU group 20B, and the ONU group 20C are not capable of receiving the signal (S-10010D, S-10010B, and S-10010C). It is further assumed that a ranging request signal 20000-B that is transmitted as the optical signal LA10010 at the optical intensity to be described below, which is one level higher than the optical signal LA10000, is receivable only by the ONU group 20B. It is also assumed that the optical intensity of this signal is so strong for the ONU group 20A and the ONU group 20D that it is feared that the optical receivers thereof may be crashed or end up with failure. On the other hand, the optical intensity is too low to become receivable by the ONU group 20C. In addition, the ranging request signal 20000-C transmitted as the optical signal LA10020 at the optical intensity which is one level higher than the optical signal LA10010 is receivable only by the ONU group 20C. This signal is so strong for the ONU group 20A, the ONU group 20D, and the ONU group 20B that it is feared that the optical receivers thereof may be crashed or end up with failure.

Each of the ONUs in the ONU group 20A which has properly received the signal transmits a ranging response signal 20010-A to the OLT 10 (S-10020A). The OLT 10 which has received the ranging response signal 20010-A (S-10030A) determines that it is possible to communicate with the ONUs in the ONU group A which transmitted the ranging response signal 20010-A. This determination includes that the communication is possible at the optical intensity LA10000 at which the ranging request signal 20000-A is transmitted. Then, the OLT 10 executes the ranging process based on the ITU-T standard G. 984.3, such as individually measuring the Round Trip Delay (RTD) at the optical intensity LA10000 up to each of the ONUs, and deciding a value of Equalization Delay (EqD) based on the result of the measurement (20020-A). On this occasion, the OLT 10 measures the communication time until reaching each of the ONUs, based on the result of the ranging process. This communication time obtained here can be utilized for setting an absolute time (OLT side management time) from the OLT 10 to each of the ONUs. This absolute time is useful for each ONU to properly recognize arrival time information as to a frame directed to each of the ONUs, as shown in an optical intensity map which will be described below. This is because the ONU is allowed to obtain the time information to be set in its own device based on the time information (absolute time) managed on the OLT side. Therefore, it is possible to set in the ONU, a boundary of a basic frame cycle from the ONU 10 or the time when the frame reaches each ONU. As described above, in the present example, a method for setting the absolute time is not particularly limited. Specifically, it is possible to employ the time setting method as described in the Japanese Patent Application No. 2007-231379.

The OLT 10 configures settings until setting the absolute time on each of the ONUs in the ONU group 20A (20030-A), and provides, to each of the ONUs with which communication has been established until then, a notice to configure the intensity controller 2311 within the ONU in such a manner that a receive operation is started from the scheduled time for starting normal operation, and all the received signals are blocked until the scheduled time (20040-A, 20050-A).

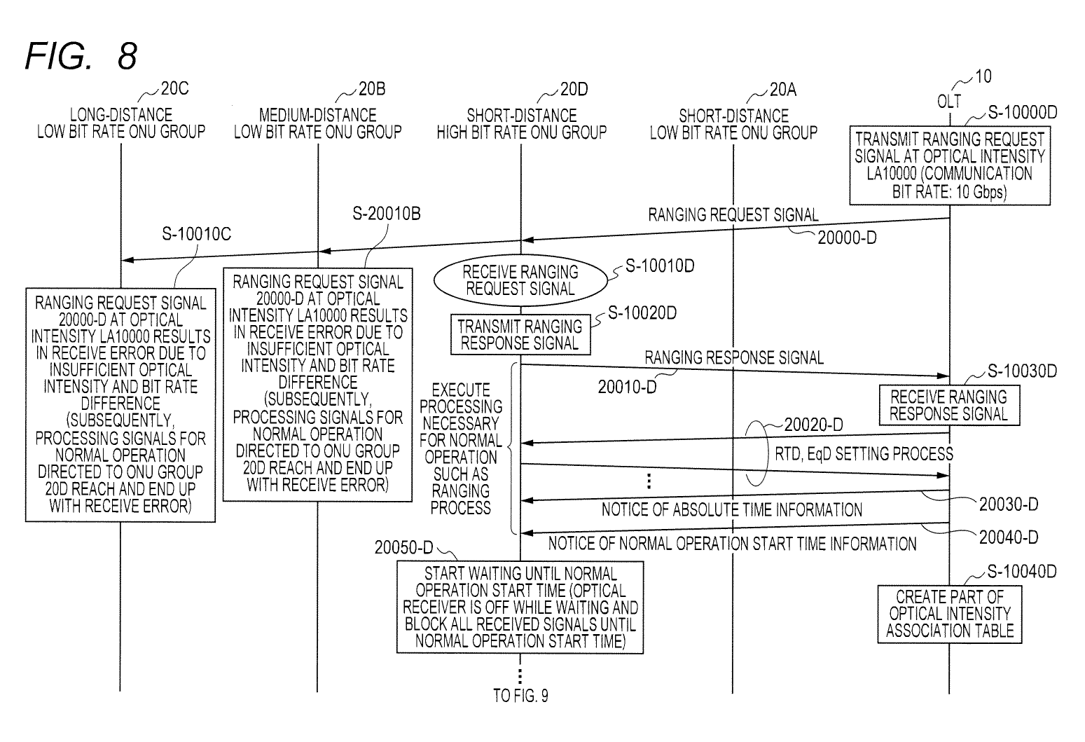

With reference to FIG. 8, an explanation will be made as to the ranging operation which is performed between the OLT and each of the ONUs belonging to the ONU group 20D, at the time when the PON system is started up. In FIG. 8, the ONU group 20A that has finished the ranging process is in the state where the ranging request signal 20000-D is blocked. On the other hand, the ONUs in the ONU group 20D, the ONU group 20B, and the ONU group 20C, still maintain the state of waiting for a ranging request signal from the OLT 10, those ONU groups having failed to properly receive the ranging request signal 20000-A at the aforementioned minimum optical intensity LA10000 and at the communication bit rate 2.5 Gbits/s, due to the distance between the OLT-ONU or influence of transmission loss, and due to a difference in communication bit rate.

The OLT 10 which finished the ranging process with the optical signal (at the optical intensity LA10000 and the communication bit rate 2.5 Gbps) and defining the absolute time for each pertinent ONU subsequently changes the communication bit rate to 10 Gbits/s, sets the transmitted optical intensity to the intensity necessary for the communication at the bit rate, and transmits the ranging request signal 20000-D again to each of the ONUs (S-10000D). On this occasion, the ONUs in the ONU group 20A which previously finished the ranging process just before are given a directive from the OLT to block all the received signals until the scheduled time for stating the normal operation, and therefore those ONUs block the signals at the optical intensity LA10000 and at the communication bit rate of 10 Gbits/s which are arriving this time, thereby protecting the optical receiver in its own ONU (20050-A). On the other hand, the ONUs in the ONU group 20B and in the ONU group 20C fail to catch the signal because the receiver sensitivity of the O/E 2310 is insufficient or because the communication bit rate is different even though the receiver sensitivity is within an adequate range, resulting in that receiving is disabled due to a signal error or the like. Since the ONUs in the ONU group 20D successfully recognize the ranging request signal 20000-D for the first time according to the signal transmitted at the optical intensity LA10000 and at the communication bit rate 10 Gbits/s, the ONU performs the ranging process and setting of the absolute time information with the OLT 10. Since the details of the processing at this timing are the same as the aforementioned processing between the OLT 10 and the ONU group 20A, an explanation will not be made. Thereafter, The OLT 10 provides, to each of the ONUs in the ONU group 20D, a notice to configure the intensity controller 2311 within the ONU in such a manner that all the received signals are blocked until the scheduled time for starting the normal operation (20020-D).

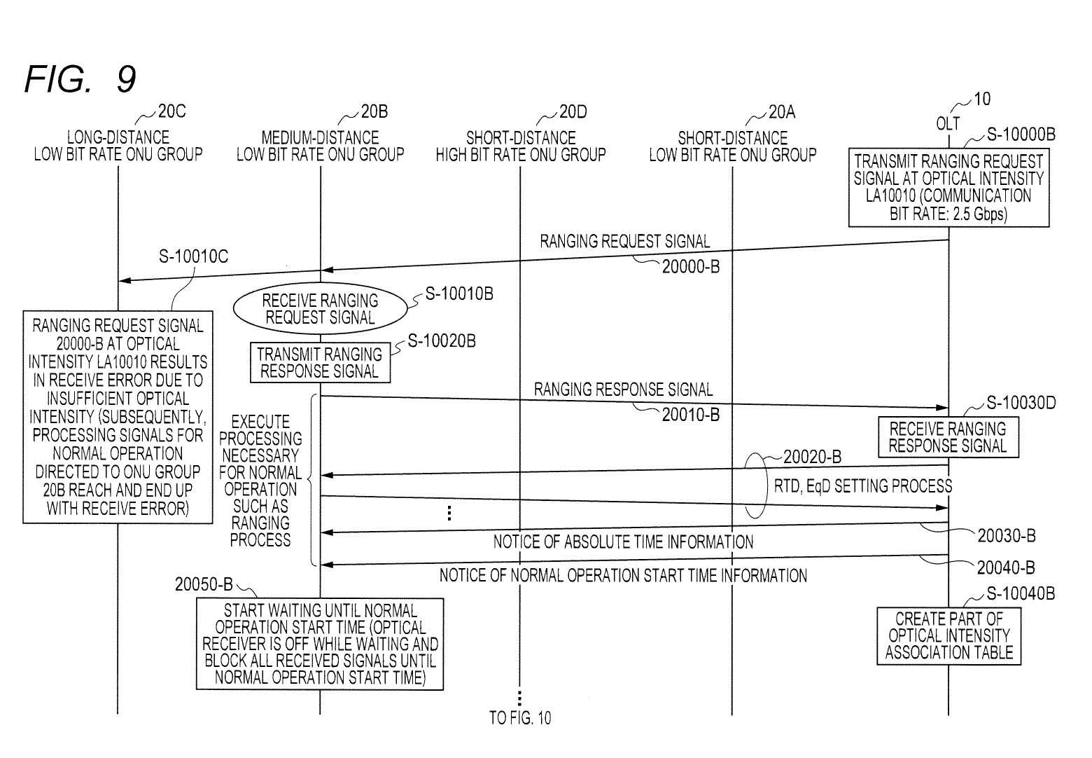

With reference to FIG. 9, an explanation will be made as to the ranging operation performed between the OLT and each of the ONUs belonging to the ONU group 20B at the time when the PON system is started up. In FIG. 9, the ONU group 20A and the ONU group 20D that have finished the ranging process are in the state of blocking the ranging request signal 20000-B. On the other hand, the ONUs in the ONU group 20B and the ONU group 20C, which have failed to properly receive the ranging request signals 20000-A and 20000-D according to the aforementioned optical signal (at the optical intensity LA10000 and at the communication bit rates 2.5 Gbits/s or 10 Gbits/s), due to the distance between the OLT-ONU or influence of transmission loss, and due to a difference in communication bit rate, still maintain the state of waiting for a ranging request signal from the OLT 10.

The OLT 10, after finishing the ranging process and defining the absolute time for each pertinent ONU, subsequently changes the optical intensity to different optical intensity LA10010 which is made one-level higher than LA10000, and again transmits the ranging request signal 20000-B (here, the communication bit rate is 2.5 Gbits/s) to each of the ONUs (S-10000B). On this occasion, each of the ONUs in the ONU group 20A and in the ONU group 20D is given a directive from the OLT to block all the received signals until the scheduled time for the stating normal operation, and therefore those ONUs block the signals at the optical intensity LA10010 which are arriving this time and protect the optical receiver in each own ONU (20050-A, 20050-D). Otherwise, there is a possibility that the ONUs in the ONU group 20A and in the ONU group 20D after finishing the ranging process just before may cause a malfunction such as a breakdown or a crash of the optical receiver of its own ONU because the optical intensity LA10010 which is made one-level stronger than the optical signal LA 10000 has reached.

On the other hand, as for the ONUs in the ONU group 20C, similar to the case described above, the level of the receiver sensitivity of the O/E 2310 is not sufficient, and the ONUs in the ONU group 20C become disabled to receive the signal due to a signal error and the like. However, since each of the ONUs in the ONU group 20B successfully recognizes the ranging request signal 20000-B for the first time according to the signal transmitted at the optical intensity LA10010 and at the communication bit rate 2.5 Gbits/s, each of the ONUs in the ONU group 20B performs the ranging process and sets the absolute time information with the OLT 10. Since the details of the processing at this timing are the same as the aforementioned processing between the OLT 10 and each of the ONUs, performed at aforementioned optical intensity LA10000, an explanation will not be made. Thereafter, The OLT 10 provides a notice to configure the intensity controller 2311 within the ONU in such a manner that all the received signals are blocked before the scheduled time for starting the normal operation (20020-B).

After the aforementioned processing is executed, a ranging request signal is issued from the OLT 10 under the condition that the optical intensity is LA10010 and the communication bit rate is 10 Gbits/s, but this procedure is not described here.

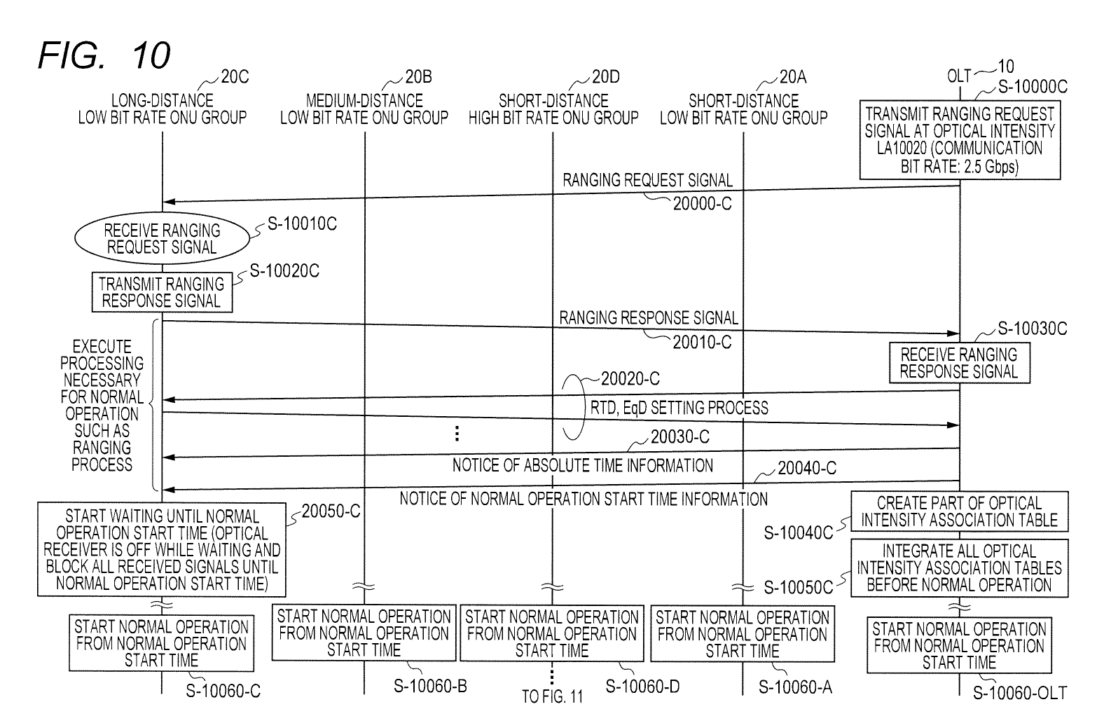

With reference to FIG. 10, an explanation will be made as to the ranging operation executed between the OLT and each of the ONUs belonging to the ONU group 20C at the time when the PON system is started up. This ranging operation is executed after the ranging processes for the respective ONU groups 20A, 20D, and 20B are completed as shown in FIG. 7, FIG. 8, and FIG. 9. In FIG. 10, the OLT 10 finished the aforementioned processing at the optical intensity LA10010, and then transmits a ranging request signal at the optical intensity LA10020 further one-level higher, and performs the same processing as described above between the OLT 10 and the ONU group 20C that has returned the ranging response signal (steps of the processing in this case are the same as the aforementioned processing for the ONU group 20A and the ONU group 20B, and therefore, an explanation will not be made). Also on this occasion, each the ONUs for which the optical intensity LA10020 is too strong (the ONU group 20A, the ONU group 200, and ONU group 20B which have already finished a series of processing with the OLT 10 at the optical intensity LA10000 and LA 10010) blocks the received signals according to the directive from the OLT 10, and therefore there occurs no malfunction such as a breakdown or a crash of the optical receiver in its own

ONU device.

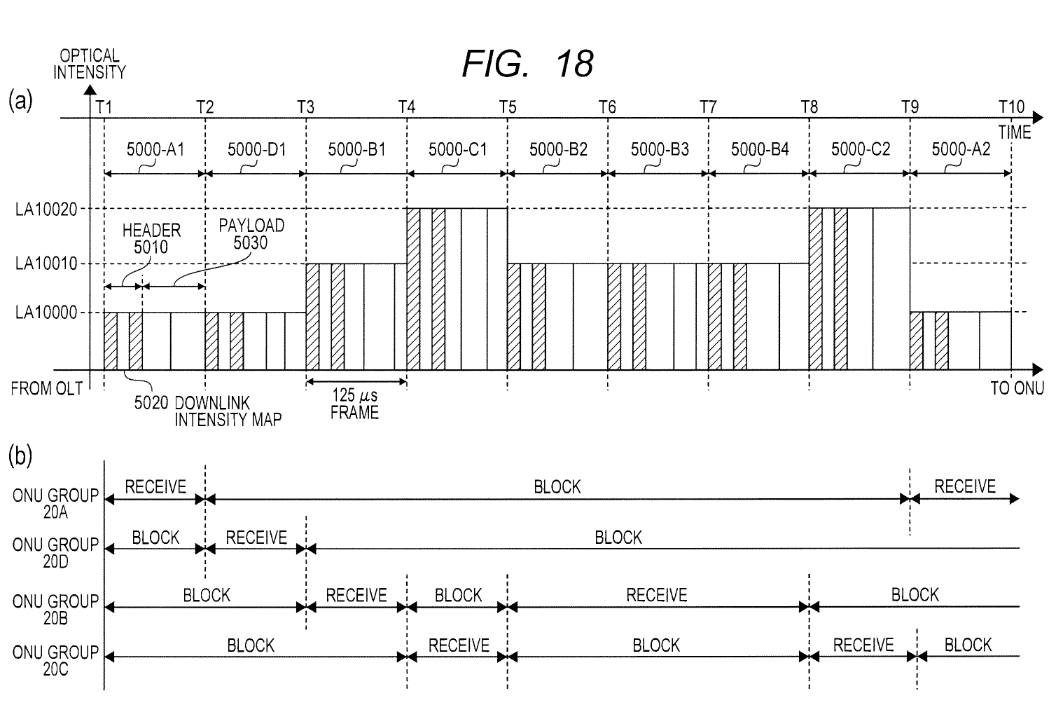

As described above, the ranging process and the notice of the absolute time are performed while the OLT 10 gradually increases the intensity of the optical signal, whereby the OLT 10 is allowed to execute the ranging process and set the absolute time for all the ONUs 20 controlled by the OLT 10, and eventually, the OLT 10 and all the ONUs 10 shift to the normal operation (S-10060-OLT, S-10060-A, S-10060-D, S-10060-B, and S-10060-C). On this occasion, if the time when each optical level signal initially reaches is designated as the normal operation start time (in the example of FIG. 18 described below, the time corresponds to T1 for the ONU group 20A, the time corresponds to T2 for the ONU group 20D, the time corresponds to T3 for the ONU group 20B, and the time corresponds to T4 for the ONU group 20C), all the ONUs 20 are enabled to receive without causing errors or failures, from the downlink frame that reaches just after the operation start time.

The OLT 10 gradually increases the optical intensity at the time of transmitting the downlink signal, and performs the ranging process in the ONUs, sequentially from the ONU at the closest connection distance to the farthest ONU. It is to be noted here, there are roughly two ways for the OLT 10 to recognize completion of the ranging process with the ONU group at a certain distance.

One way corresponds to a method where a Serial Number (SN) list is held inside the OLT 10 upon establishing ONU connection (at the time when ONU is distributed being addressed to a user), and the OLT 10 refers to the list prepared by connection distance, to know whether or not starting of the ONUs associated with the pertinent SN is entirely completed.

The other way corresponds to a method where a series of starting processes is executed periodically, so as to know by polling, whether or not a newly connected ONU exists. In this method, when the ONU group 20A to the ONU group 20C are started, all the serial numbers (except already-connected ONUs) are sequentially polled, while incrementing or decrementing the number only gradually (in this case, the OLT 10 has no prior information as to the SN list). In this case here, one ONU for each group is targeted. It is alternatively possible to employ a method that polling of all the serial numbers as to the ONU group 20A is completed first, and then the ONU group 20D is subsequently checked.

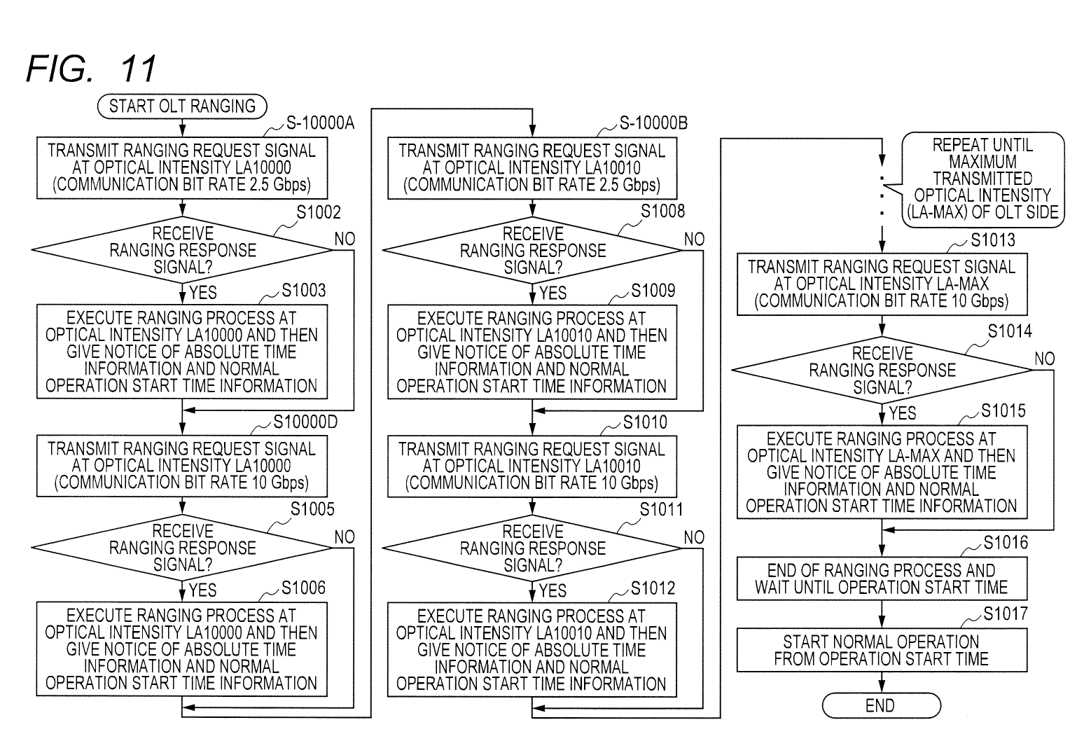

With reference to FIG. 11, a flow of the ranging process by the OLT 10 will be explained. In FIG. 11, the steps from S-10000A to 51003 correspond to the sequence processing in FIG. 7. Similarly, the steps from S-10000D to S1006 correspond to the sequence processing in FIG. 8, and the steps from S-10000B to S1009 correspond to the sequence processing of FIG. 9. More particularly, the step S1002 is a confirming process that is executed within the time starting from the S-10000A until receiving the ranging response signal S-10030A in FIG. 7. As a result of S1002, when it is confirmed that the ranging response signal is properly received, a series of ONU setting process from the 20020-A to S-10040A is performed. This series of processing as a whole is described as the step S1003 in FIG. 11.

FIG. 11 has similar correspondences with FIG. 8 and FIG. 9 as those described above. The step S1005 is a confirming process that is executed within the time starting from the S-10000D until receiving the ranging response signal S-10030D in FIG. 8, and further as a result of S1005, when it is confirmed that the ranging response is properly received, a series of ONU setting process from the 20020-D to S-10040D is performed (S1006). Since the correspondence with FIG. 9 is the same as described above, an explanation will not be made.

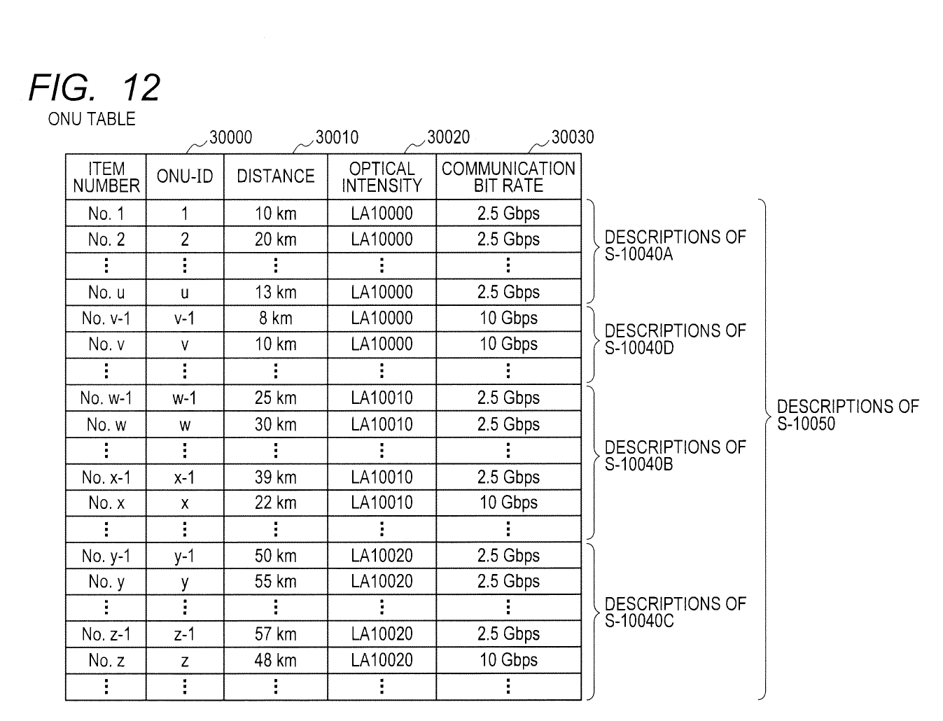

As stated above, starting process is performed sequentially from the ONU 20 group being the closest to the OLT 10, and when the ranging process for the ONU group located at the farthest from the OLT 10 is completed, this flow is completed. The ranging process for the ONU group at the farthest distance corresponds to the steps S1013 to S1015. Then, after passing through the confirmation of the ranging process completion and waiting until the operation start time (S1016), the operation is started (S1017). It is to be noted that in the confirmation of the completion of the ranging process and the waiting process in the step S1016, a process for integration of an optical intensity table will be conducted as shown in FIG. 12.

With reference to FIG. 12, an explanation will be made as to the ONU table generated and held within the OLT 10 as a result of starting the PON system. The table as shown in FIG. 12 is generated by the OLT 10 in the step S-10050 (FIG. 10) as a result of the ranging process as described with reference to FIG. 7 to FIG. 10. The ONU table integrates the distance information from the OLT and optical intensity necessary for the communication, as to each ONU. The ONU table is held in the ranging/DBA information database 1061 within the OLT 10.

The ONU table shows a correspondence between the ONU-ID 30000 being an identifier of individual ONU and the distance information 30010 indicating a distance from the OLT 10 to this ONU. The ONU table is generated every time the ranging process is completed, the ranging process being performed at each level of optical intensity. In other words, while the OLT 10 processes the ONU-ID 30000 and the distance information 30010 at the time of ranging, the OLT 10 is able to generate the ONU table by adding the optical intensity information 30020 and the communication bit rate information 30030, which are used in the OLT-ONU communication during the processing (S-10040A, S-10040D, S-10040B, and S-10040 C). In addition, this table information is generated every time the OLT 10 changes the optical intensity to perform the ranging process, and finally integrates those information items, thereby enabling generation of the table information as to all the ONUS (S-10050). On the basis of the table information, the OLT 10 utilizes the ONU table according to destination information or the like, as to a frame transferred from the IF 1100, thereby determining the optical intensity which allows the destination ONU to receive the frame properly. In addition, the OLT 10 also uses the optical intensity information 30020 and the communication bit rate information 30030 to generate a downlink intensity map which will be described in detail in the following. With this configuration, it is possible to avoid a situation where the receiver ends up with failure or crash due to too high optical intensity being inputted into the ONU, and a situation where the input optical intensity is so low that the signal is received as an error signal. In addition, the communication bit rate information for each ONU is managed, and accordingly it is possible to add a directive as to a receiving at each communication bit rate. Therefore, various PON systems are allowed to be accommodated in a mixed manner. It is to be noted that the values in the table information as shown in FIG. 12 represent just one example, and those values have no impact on the feature of the present invention.

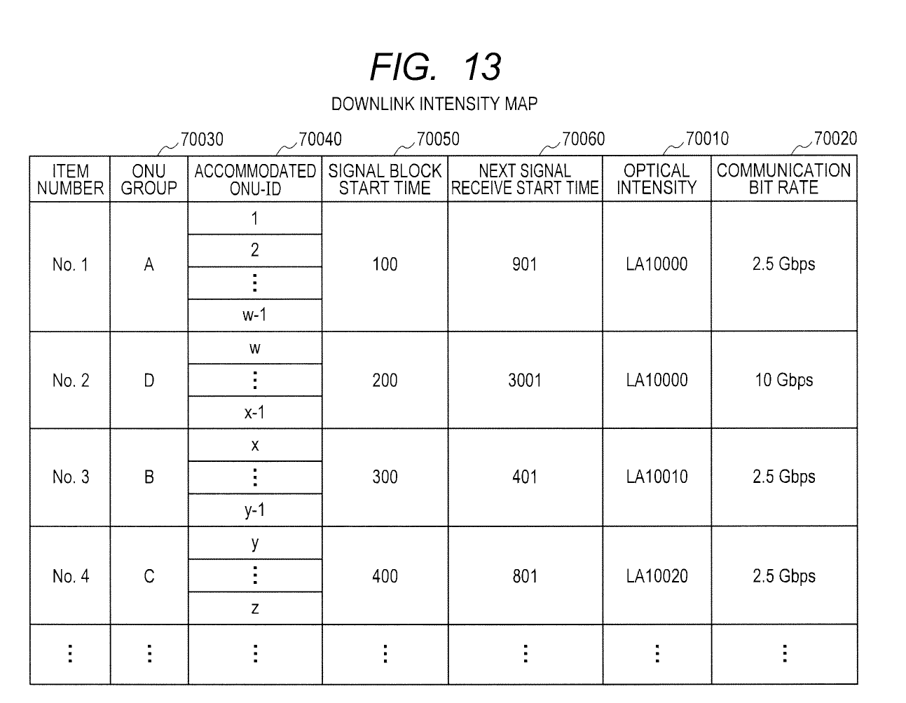

With reference to FIG. 13, a downlink intensity map used when a downlink frame is generated will be explained. In FIG. 13, when the OLT 10 receives a frame transferred from the access network 90, the PON controller 1000 specifies a destination ONU from the header information of the received frame, and checks a relationship between all the ONUs 20 generated at the time of ranging and suitable optical intensity for transmission (database in FIG. 12), whereby it is possible to decide the optical intensity at which the payload is to be transmitted (70010). If various communication bit rates exist in an identical network, such as 10 GPON and GPON, it is further possible to check the communication bit rate information (70020). According to the optical intensity thus decided and the communication bit rate information for each ONU, the ONUs having the same optical intensity and the same communication bit rate are grouped as an ONU group (70030), and the ONU-IDs contained in the ONU group are held in the table (70040). In the present example, it is assumed that the downlink intensity map is used on an ONU group basis. It is a matter of course that the downlink intensity map may be managed ONU by ONU, not only the ONU group basis.

In order to add time information for determining the time for receiving/blocking a signal to the aforementioned information when the downlink frame processor 1210 generates a downlink frame, the transmission plan decision part 12108 as shown in FIG. 4 monitors the packet buffers 12101 and decides the signal block start time (70050) and the next signal receive start time (70060) in the form of absolute time for each ONU. A detailed explanation will be made later as to the way how the signal transmission plan decision part 12018 decides time information for each ONU. In the present example, the OLT 10 and each ONU 20 use common time information to perform various processes represented by the frame processing. These various processes are managed by the OLT and the ONU, based on the aforementioned absolute time being a standard each other. However, it is also possible to perform the processes using the time information relative to a time assumed as a standard (relative time). As means for synchronizing time between the OLT and the ONU, there is an example such as time synchronization according to GPS function.

The downlink intensity map is stored in the ranging/DBA information database 1061, further mounted in the header of the downlink frame described below, and it is used as the downlink intensity map for each ONU to acknowledge a timing when its own device is to receive a signal and a timing when to block a signal.

It is to be noted that specific numeric values shown in FIG. 13 represent just an example, and the present example is not particularly limited to these values. Individual numeric values are to show a table configuration for convenience of explanation, in order to figure out a relationship among the signal from upstream network, the ONUS generated at the time of ranging, and suitable optical intensity.

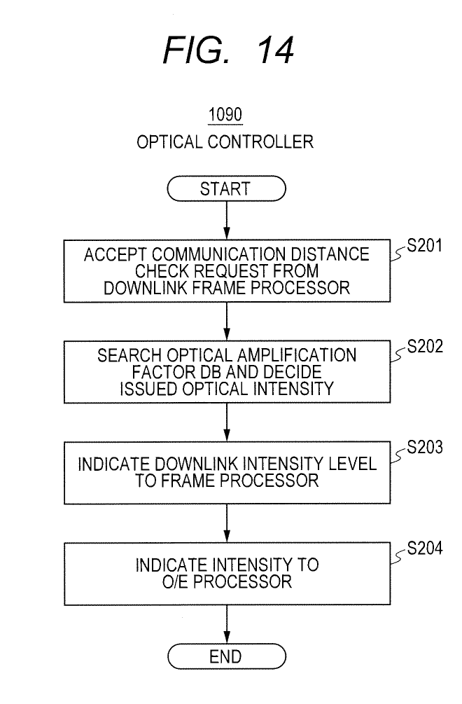

With reference to FIG. 14, a processing flow in the optical controller 1090 of the OLT 10 will be explained.

The downlink frame processor 1210 of the OLT 10 searches the downlink route information database 1211, using, as a key, the header information extracted from the downlink frame received by the Service Network Interface (SNI). Issued optical intensity is queried based on the Port-ID information given to the GEM frame which is available at this stage. As an alternative method, the optical controller 1090 searches the ranging/DBA information database 1061 for the transmission distance up to the ONU 20 (or ONU group identifier information to which the ONU belongs), and according to the result, searching the optical amplification factor information database is performed. FIG. 14 is used to explain the latter case. In FIG. 14, the optical controller 1090 accepts a request from the downlink frame processor 1210 to check which ONU group the ONU 20 belongs (S201). The optical controller 1090 receives this control signal, refers to the optical amplification factor database 1091 determined in advance based on the ranging/DBA information database 1061, thereby specifying the ONU group to which the ONU 20 belongs and deciding, for the frame processor 1210, the signal intensity (amplification factor) when a signal is transmitted to the ONU 20 (S202). On this occasion, if the ONU ID associated with the Port-ID is identical (or the ONU group is identical), the optical amplification factor becomes the same value. Therefore, the optical amplification factor database 1091 employs a configuration example which stores the table information as shown in FIG. 12 and FIG. 13 developed from the ranging/DEA information database 1061 and information obtained by partially processing some of the table information.

After deciding the signal intensity for the signal directed to the ONU 20, the optical controller 1090 notifies the frame processor 1210 of the intensity information (S203). In addition, the optical controller 1090 notifies the O/E processor 1310 of the optical intensity information which is used when the downlink frame (GEM frame) including the Port-ID is outputted (S204), and then the flow ends. The former intensity information is used for generating and inserting the downlink intensity map into the downlink frame header, and the latter intensity information is used for controlling the optical module when the downlink frame is actually outputted. The intensity controller 11000 of the O/E processor 1310 is in charge of this optical functional coordination.

It is to be noted that in the flow described above, when the optical intensity is adjusted, a method which follows a directive from the optical controller 1090 is taken up as an example. However, it is further possible to implement the adjustment configuration, by employing means which accepts a request from the intensity controller 11000, then refers to the optical amplification factor database 1091 from the optical controller 1090, thereby collecting the intensity information.

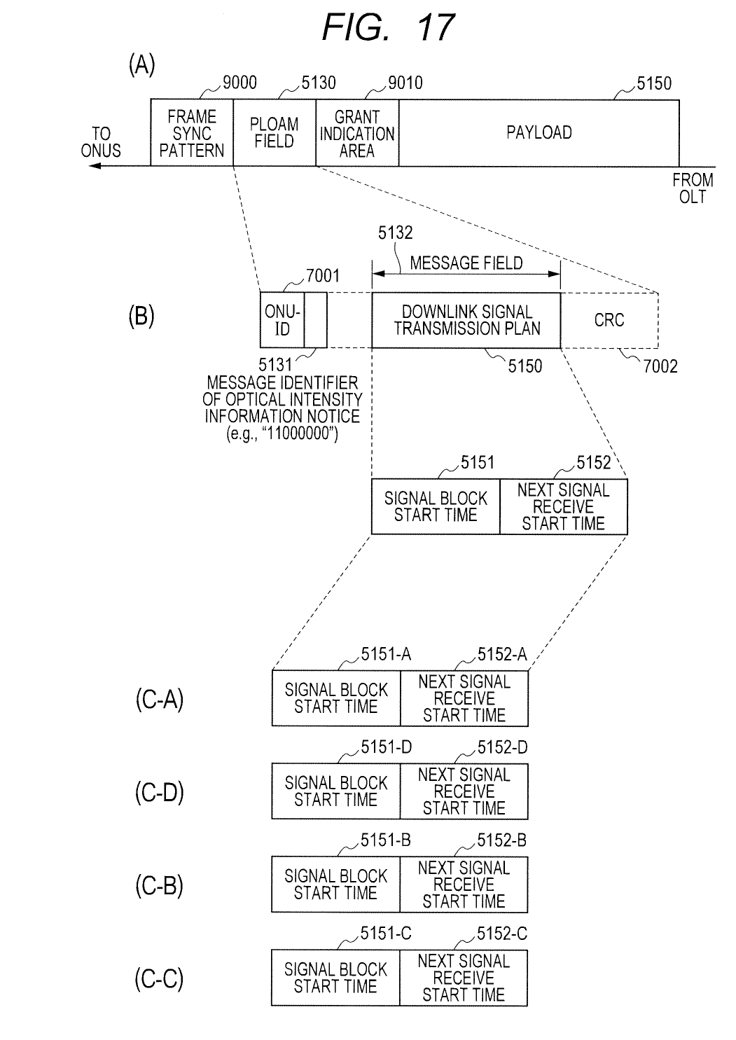

On the basis of the intensity information for transmission obtained in step 203, a downlink intensity map to be inserted into the downlink frame header is generated in the downlink frame processor 1210, and completes the process for configuring the downlink frame which is transmitted to the PON section 80. The frame configured here corresponds to the frame as illustrated in FIGS. 17A to 17C-C described later.

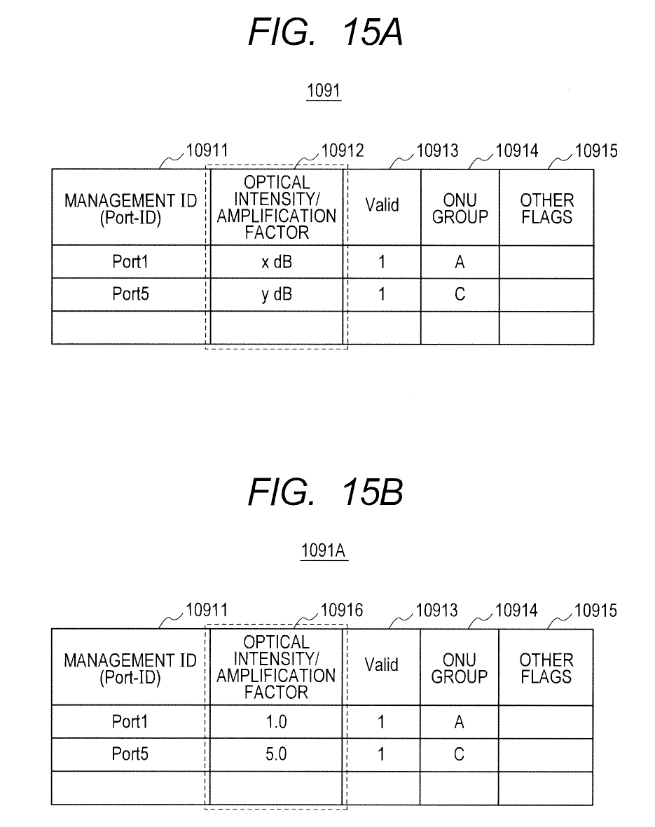

With reference to FIGS. 15A and 15B, an explanation will be made as to the configuration of the optical amplification factor database 1091 held by the optical controller of the OLT 10. The optical amplification factor database 1091 is used to decide the intensity for transmission (optical intensity or amplification factor 10912) according to the Port-ID of the frame in the step 202 of the flowchart as shown in FIG. 14.

The optical amplification factor database 1091 is used to manage the optical intensity of the transmitted signal of the downlink frame, for the destination ONU 20. In FIG. 15A and FIG. 15B, the Port-ID 10911 being an identifier of the ONU 20 is used as a management ID. This is because the Port-ID is a destination identifier included in the downlink frame (GEM frame) and convenient for use. It is alternatively possible to employ a configuration such as using identifiers including ONU-ID, Serial Number (SN), and Logical Link ID (LL ID) which have been used in existing PON.

The optical amplification factor database 1091 further includes an optical intensity or amplifier factor 10912, as a parameter indicating issued intensity of the downlink optical signal for each ONU 20. FIG. 15A illustrates the state where the optical intensity is stored. As shown in FIG. 15B, it is also possible to use a variable 10916 indicating a relative amplification factor or attenuation factor, assuming as a standard, default issued intensity from the optical module (intensity of initial setting which is preset at the time of manufacturing or shipping the optical module).

A status of the individual ONU 20 is managed by the information in the valid field 10913 indicating whether an individual table entry is valid or invalid, and in the other flag field 10915. A lot of means may be applicable as a method for managing the status of the ONU 20 in the OLT 10, depending on a vender-specific implementation. The information in the valid field 10913 is used when a failure occurs or an abnormal signal is generated, and as for the information (status number) indicating the status of the ONU 20, there is a method to represent the status by a few bits in the other flag field 10915, including all information such as whether or not power is activated in the ONU 20. As an alternative method, it is possible to set the valid field 10913 as valid, when power is activated in the ONU 20, and manage information regarding subsequently performed starting, operation, maintenance management of the ONU 20, by a few bits in the other flag 10915.

It is further possible for the optical amplification factor database 1091 to store the ONU group to which each destination ONU belongs, by Port-ID 10911. The absolute optical intensity 10912 and the relative optical intensity 10916 are determined according to the difference in the ONU group. Therefore, on the stage where an operator installed the ONU 20, the ONU group 10914 is fixed and simultaneously, rough values of the optical intensity or amplification factor 10912 or 10916 are determined.

Even though the ONU groups exist at the same distance from the OLT, the optical intensity required for the communication is different if the communication bit rate is different. When the communication bit rate is changed from 2.5 Gbits/s to 10 Gbits/s, a wavelength dispersion effect becomes more significant by a factor of approximately 16 and the S/N ratio increases by a factor of 4, and accordingly, the transmission distance is considerably reduced. Therefore, in order to generate this database 1091, the optical intensity or amplification factor 10912 or 10916 is determined, considering the influence of optical characteristics caused by the distance up to the ONU group and the communication bit rate.

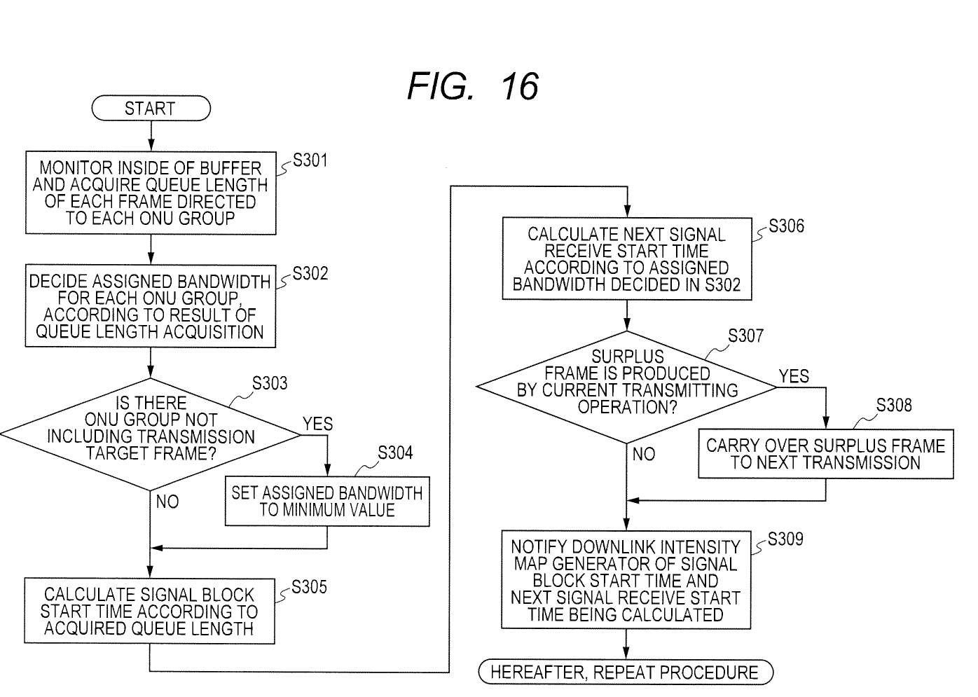

With reference to FIG. 16, an explanation will be made as to the operation of the transmission plan decision part 12108 in the OLT 10, at the time of receiving the downlink frame. In FIG. 16, the header analyzer 12105 provided in the downlink frame processor 1210 of the OLT 10 analyzes the header information of the frames transferred from the access network 90, and distributes the frames into packet buffers 12101-1 to 12101-3 according to the ONU groups, respectively designated as target destinations of the frames. Here, it is assumed that assignment of the packet buffer destinations (buffers and queues) in association with the destination ONU groups are determined at the time when the system is started up.

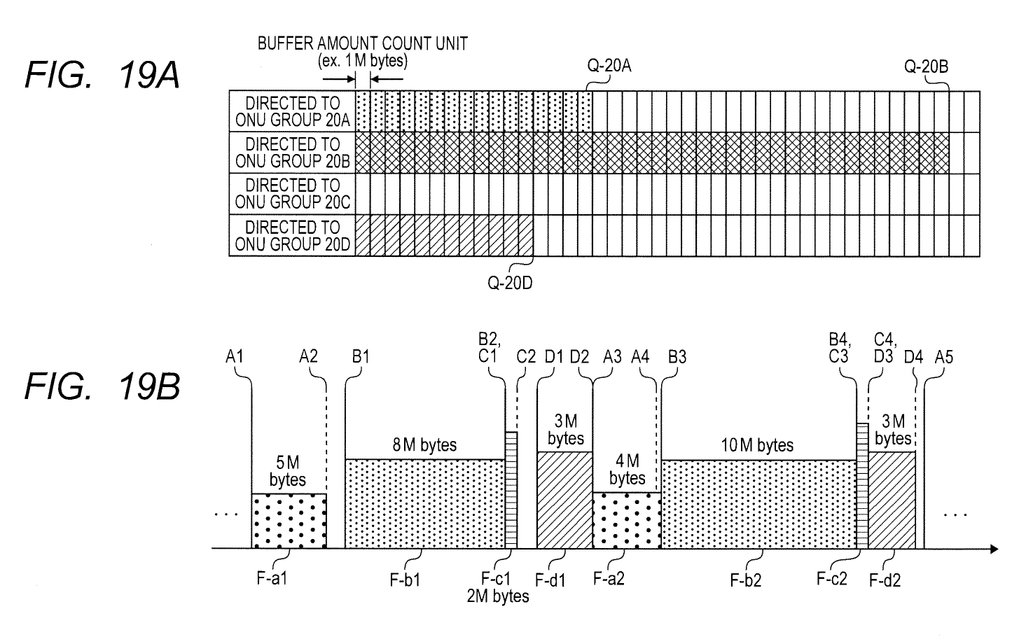

The transmission plan decision part 12108 periodically monitors the inside of the buffers sequentially, and acquires a queue length of each frame directed to each ONU (S301). The transmission plan decision part 12108 decides an assigned bandwidth for each ONU group, according to a ratio of the acquired queue length (S302). The transmission plan decision part 12108 determines whether or not there exists an ONU group which does not have a transmission target frame (S303). If the condition is true, the transmission plan decision part 12108 sets the assigned bandwidth for the pertinent ONU to be a minimum value (S304). This minimum assigned bandwidth is assumed in the present example, as corresponding to one unit, when a transmission waiting data amount within the buffer is counted in units of a certain amount, but this is not the only example (details regarding a method for monitoring the buffer amount will be described with reference to FIG. 19). Furthermore, in the present example, bandwidth assignment for downlink signals is performed at an identical cycle for all the ONU groups, but the cycle is not particularly limited. The most fundamental unit corresponds to a basic frame cycle of the downlink signal (125 microseconds). In the following, an explanation will be made using as an example, a downlink signal configuration using 125 microseconds as a cycle. However, when the present example is applied, it is not necessary to limit the buffer monitoring cycle to the aforementioned cycle.

The time when each ONU group starts receiving the frame to be transmitted this time is determined when the startup process is performed, if it is immediately after the operation start. On the other hand, if it is during the normal operation, the time is determined according to the time information of the downlink intensity map within the frame previously received. In the step 303, if the condition is false, or after the step 304, the transmission plan decision part 12108 calculates a signal block start time according to the acquired queue length (S305). Then, the transmission plan decision part 12108 calculates a next signal receive start time according to the assigned bandwidth for each ONU group that is decided from the acquired queue length (S306). The transmission plan decision part 12108 determines whether or not any surplus frame exists, after the present transmission operation is performed (S307). Here, a ratio of the bandwidth used for each ONU group under normal operation is based on the result of previous buffer monitoring as described above. Therefore, when traffic directed to a particular ONU group is increased, all of the frames monitored this time cannot be transmitted by one-time transmission operation. If the condition in the step 307 is true, the surplus frame is carried over as a frame for the next outputting (S308).

If the condition of the step 307 is false or after the step 308, the transmission plan decision part 12108 notifies the downlink intensity map generator 12107 of the time information thus decided (the signal block start time and the next signal receive start time), reflects the information on the downlink intensity map (S309), and ends the processing. The transmission plan decision part 12108 repeats the operations from the step 301 to the step 309, thereby sequentially deciding the frame transmission plan of the frames that are transferred from the access network 90.

With reference to FIGS. 17A to 17C-C, an explanation will be made as to the format of the frame on which the downlink intensity map is mounted. In the PON system 1, in order to avoid breakdown of the optical receiver of the ONU 20, and to avoid issuing of useless error message from the ONU that is not a target on which the signal is received, the transmission timing of the downlink signal from the OLT 10 to individual ONU 20 is notified according to the downlink intensity map.

In the GPON, in order to allow each ONU to identify and process the signal from the OLT as shown in FIG. 17A, the signal from the OLT directed to each ONU is configured in such a manner as adding the following items at the head of the signal transmitted from the OLT to each ONU: a frame sync pattern 9000 for identifying the head; a Physical Layer Operation, Administration, and Management (PLOAM) field 5130 for transmitting information of monitoring, maintaining, and controlling; and a header referred to as a grant indication area 9010 (also referred to as an overhead). Those are added to the data 5120 (also referred to as a payload) which is time-division multiplexed being directed to each ONU.

In FIG. 17A, the PLOAM field is employed, which is a control message area included in the downlink signal header information, according to ITU-T Recommendation G. 984.3. As a control frame identifier 5131, an identifier (an open ID that is usable uniquely by the vendor, and in this example here, it is assumed as “11000000”) may be employed, which indicates that the PLOAM message is a uniquely defined message including “optical intensity information”. A downlink signal transmission plan 5150 is inserted in the message field 5132 within the PLOAM, the plan indicating the timing when the ONU 20 group is supposed to receive/block the frame. In the example of FIG. 17A, the downlink signal transmission plan 5150 stores a signal block start time 5151 and a next signal receive start time 5152, according to the downlink signal transmission plan decided in the OLT 10 for each ONU group.

FIGS. 17C-A, 17C-D, 17C-B, and 17C-C respectively indicate signal configurations of the transmission plan signals directed to the ONU 20A-R, the ONU 20D-R, the 20B-R, and the ONU 20C-R. With reference to FIG. 2, and FIG. 17C-A, the ONU 20A-R starts blocking the signal at the optical intensity and at the communication bit rate that the ONU group A is not supposed to receive, from the signal block start time 5151-A, and prevents crash of the optical receiver in the ONU and occurrence of signal errors. Then, from the next signal receive start time 5152-A, the ONU 20A-R releases blocking and starts receiving signals. The downlink intensity map that is notified to the ONU 20D-R according to FIG. 17C-D, the downlink intensity map that is notified to the ONU 20B-R according to FIG. 17C-B, and the downlink intensity map that is notified to the ONU 20C-R according to FIG. 17C-C have similar configurations, and those maps respectively include the signal block start times 5151-D, 5151-B, and 5151-C, and the next signal receive start times 5152-D, 5152-B, and 5152-C. The operations of the ONU 20D-R, the ONU 20B-R, and the ONU 20C-R are the same as those of the ONU 20A-R.

It is to be noted that in the present frame configuration, it is not possible for the ONU just after starting the system to know the initial signal receive start time. Therefore, in the present example, the initial signal receive start time is notified to each ONU group at the time of system startup process.

It is further possible to employ a method for giving a directive as to the time information on the ONU basis, other than specifying the downlink intensity map on the ONU group basis.

With reference to FIGS. 18A and 18B, an explanation will be made as to the optical signal intensity of the downlink frame outputted from the OLT, and receiving status of the ONU. FIG. 18B illustrates a signal configuration, assuming the status that four groups 20A, 20D, 20B, and 20C, by distance and communication bit rate, constitute the ONU groups. The frame configuration shown in FIG. 18A uses the PLOAM message shown in FIGS. 17A to 17C-C, as the downlink intensity map. In FIG. 18A, the vertical axis represents the optical intensity and the horizontal axis represents the elapsed time. On the horizontal axis, the time at the leftmost is the earliest, and along with proceeding to the right, frames outputted at a later time are shown. FIG. 18A illustrates the configuration of signals on the optical fiber at a certain time, and it shows the status that signals from the OLT 10 to the ONU 20 are transmitted from the right to the left.

In the present example, the communication distances of the ONUS 20 are significantly different from one another, and it is assumed that ONUs having different communication bit rates exist in a mixed manner within one network. Therefore, when signals are issued from the OLT 10 to the ONU 20, it is necessary to adjust the optical intensity with respect to each destination ONU group, so that each ONU is allowed to receive the optical signal, at the time when the optical signal reaches each of the ONUS, on the ONU group basis. In order to achieve this, a method for configuring the frame will be explained hereinafter.

In FIG. 18A, a downlink frame is transmitted to each ONU group, using a 125-microsecond basic frame as a unit according to the basic cycle of the PON. Since the optical intensity for transmission and the communication bit rate are different for each basic frame of 125 microseconds, it is determined, with respect to each basic frame of 125 microseconds, whether or not receiving by the ONU side is possible.

On the ONU side, it is possible to determine the timing (top position) of the downlink signal to be received by the ONU itself, and that of the downlink signal to be blocked, by using the signal block start time and the next signal receive start time within the downlink intensity map. If an explanation is made along with reference to FIG. 18A and 18B, the OLT 10 notifies each ONU group of the initial signal receive start time, at the startup time of the system. In the example here, as the initial signal receive start time, the ONU group 20A assumes the time T1, the ONU group 20D assumes the time T2, the ONU group 20B assumes the time T3, and the ONU group 20C assumes the T4. Each ONU enables the intensity controller (FIG. 5, 2311) to be ready for receiving an optical signal, right on designated time, and starts receiving the signal.

The ONU group 20A starts receiving from the OLT 10, the signal 5000-A1 transmitted at the optical intensity LA10000 and at the communication bit rate 2.5 Gbits/s from the timing of T1. The ONUs in the ONU group 20A read the downlink intensity map 5020 in the header section 5010, and recognize that the signal block start time is T2 and the next signal receive start time is T9. These time information items are determined on the basis of the result which is obtained when the transmission plan decision part (FIG. 4, 12108) monitors the packet buffers (FIG. 4, 12101) before the OLT 10 transmits the signal 5000-Al. After the packet buffers are monitored for deciding the next signal receive start time for a certain ONU group, if a frame directed to the ONU group does not exist, the next signal receive start time is set to the time after a lapse of time required for processing the frame directed to another ONU group within the packet buffer.

After analyzing the header 5010 and acquiring the time information from the downlink intensity map 5020, the ONU group 20A reads the payload part 5030 and carries out the user signal processing. Here, multiple GEM frames constitute the payload 5030, and the payload of one 125-microsecond basic frame includes user signals associated with multiple ONUS accommodated in the ONU group 20A. Each user signal is discriminated according to the Port-ID within the GEM header, it is determined whether or not the GEM frame is directed to its own device, only the payload of the GEM frame directed to its own device is processed, and the payload directed to other devices is discarded.

After completion of processing the payload 5030, the ONU group 20A starts blocking the signal from the signal block start time T2 designated by the downlink intensity map 5020, and releases the blocking from the next signal receive start time T9 to receive signals again.

The ONU group 20D operates in a similar manner to the ONU group 20A, and the ONU group 20D starts receiving from the time T2, the signal 50000-D1 at the optical intensity A10000 and at the communication bit rate 10 Gbits/s directed to the ONU group 20D, and after completing the processing of the signal 5000-D1, the ONU group 20D starts blocking the signal from T3, and releases blocking from the next signal receive start time Tx (not illustrated) to restart receiving the signal.

As for the ONU group 20B and the ONU group 20C, they operate in a similar manner as the ONU group 20A and the ONU group 20D, except that the optical intensity of the signal is different, and an explanation will not be made.

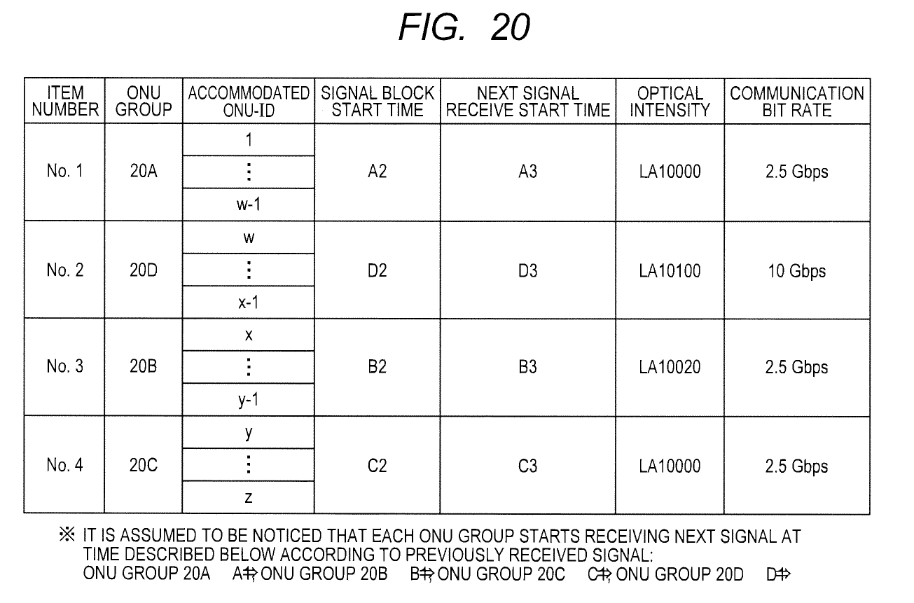

Next, with reference to FIG. 19A, FIG. 19B, and FIG. 20, a flow will be explained, where the OLT 10 dynamically coordinates the bandwidth utilization directed to each ONU from the OLT 10 during normal operation, based on the monitoring result of the packet buffers, and performs the frame transmission.

Prior to explaining FIG. 19A and FIG. 19B, it is assumed that some downlink signal frames have already been outputted from the OLT 10 to the ONU 20. On the ONU 20 side, each ONU group knows the signal receive start time according to the downlink intensity map of the previously received frame, and the ONU group 20A starts receiving at the time of Al, the ONU group 20B starts receiving at the time of B1, the ONU group 20C starts receiving at the time of C1, and the ONU group D1 starts receiving at the time of D1. Furthermore, there is shown a ratio of bandwidth used by the downlink signal newly outputted this time for each ONU group as follows: 5.0 Mbytes for the ONU group 20A; 8.0 Mbytes for the ONU group 20B; 2.0 Mbytes for the ONU group 20C; and 3.0 Mbytes for the ONU group 20D.

Under the conditions as described above, the OLT 10 receives data to be outputted to the ONUs from the access network 90, subsequent to the frame transmitted this time, and once stores the data in the packet buffers 12101-1 to 12101-3. The transmission plan decision part 12108 monitors inside the buffers and stores the newly received data into the buffers that are divided with respect to each ONU group. Thereafter, the transmission plan decision part 12108 checks the data amount for each ONU group, the amount waiting for being outputted. FIG. 19A illustrates a result that a queue length for each ONU is acquired. In FIG. 19A, the transmission plan decision part 12108 holds the data as to the queue length for each ONU. FIG. 19A shows that data directed to the ONU group 20A is accumulated in the queue length (Q-20A), data directed to the ONU group 20B is accumulated in the queue length (Q-20B), no data is to be transmitted to the ONU 20C, and data directed to the ONU group 20D is accumulated in the queue length (Q-20D).

According to the queue length being acquired, the transmission plan decision part 12108 decides a ratio of the bandwidth to be used by each ONU group at time of next transmission. With reference to the queue length of FIG. 19A is referred to, the bandwidth to be used is decided as 4.0 Mbytes for the ONU group 20A, 10.0 Mbytes for the ONU group 20B, 0 Mbyte for the ONU group 20C, 3.0 Mbytes for the ONU group 20D, as shown in FIG. 19B. Setting of the bandwidth is determined on the basis of a ratio of each queue length at the time when the buffers are monitored.

The OLT 10 calculates a signal transmission plan for each ONU group according to the acquired queue length and the setting of the bandwidth to be used when the next transmission is performed, and reflects the result on the downlink intensity map. FIG. 20 shows information used for the downlink intensity map in the current frame transmission operation by the OLT 10. In FIG. 20, it is assumed that the signal block start time of the ONU group 20A is A2, the next signal receive start time thereof is A3, the signal block start time of the ONU group 20B is B2, the next signal receive start time thereof is B3, the signal block start time of the ONU group 20C is C2, the next signal receive start time thereof is C3, the signal block start time of the ONU group 20D is D2, and the next signal receive start time thereof is D3. Those data items indicating the signal block start time and the next signal receive start time are inserted into the header part of the downlink frame and issued.

With reference to FIG. 19B again, an explanation will be made as to the signal transmission operation from the OLT 10, according to the transmission plan as shown in FIG. 20. Firstly, it is decided that the ONU group 20A starts receiving the signal at the time of A1, and it is calculated that the signal block start time is A2 and the next signal receive start time is A3, according to the queue length of the frame currently received. The OLT 10 performs the transmission in such a manner that the ONU group 20A is able to receive the frame F-a10 directed to the ONU group 20A at the time of Al. When the ONU in the ONU group 20A receives the signal F-al, the ONU reads the time information from the downlink intensity map within the header, and recognizes that the signal block start time is A2 and the next signal receive start time is A3.

Similarly to the operation of the ONU group 20A, the ONU group 20B starts receiving the signal F-b1 from the time B1, starts blocking at the time of B2, and starts receiving the next signal at the time of B3. Here, the signal directed to the ONU group 20B has the queue length, all of which is not able to be transmitted within the bandwidth upper limit being preset. Therefore, the surplus is not transmitted by the current transmission operation, and it is held until the next transmission. When the next transmission operation is performed, the surplus frame is added to the acquired queue length, and each time information item is calculated. It is to be noted that for the ONU group 20B, the bandwidth is changed from 8.0 Mbytes to 10.0 Mbytes in FIG. 19B.

Similarly to the ONU groups 20A and 20B, the ONU group 20C starts receiving from the time C1, starts blocking the signal at the time of C2, and starts receiving the next signal at the time of C3. Here, when the signal directed to the ONU group 20C is outputted this time, there is no received data to be outputted to the ONU group 20C (not accumulated in the queue) in the next downlink signal. Therefore, a minimum value of bandwidth, which is preset as a bandwidth to be assigned to the ONU group 20C, is assigned for the next time of transmitting a downlink signal (see FIG. 16). In the downlink signal transmitted next, only the frame used for notification of the downlink intensity map is transmitted (i.e., the payload does not include user data).

Similarly to the ONU groups 20A, 20B, and 20C, the ONU group 20D starts receiving the signal from the time D1, starts blocking the signal at the time D2, and starts receiving the next signal at the time of D3.

As described above, the bandwidth to be used is dynamically assigned in association with the traffic volume for each ONU group, thereby achieving an efficient transfer of the downlink intensity map.

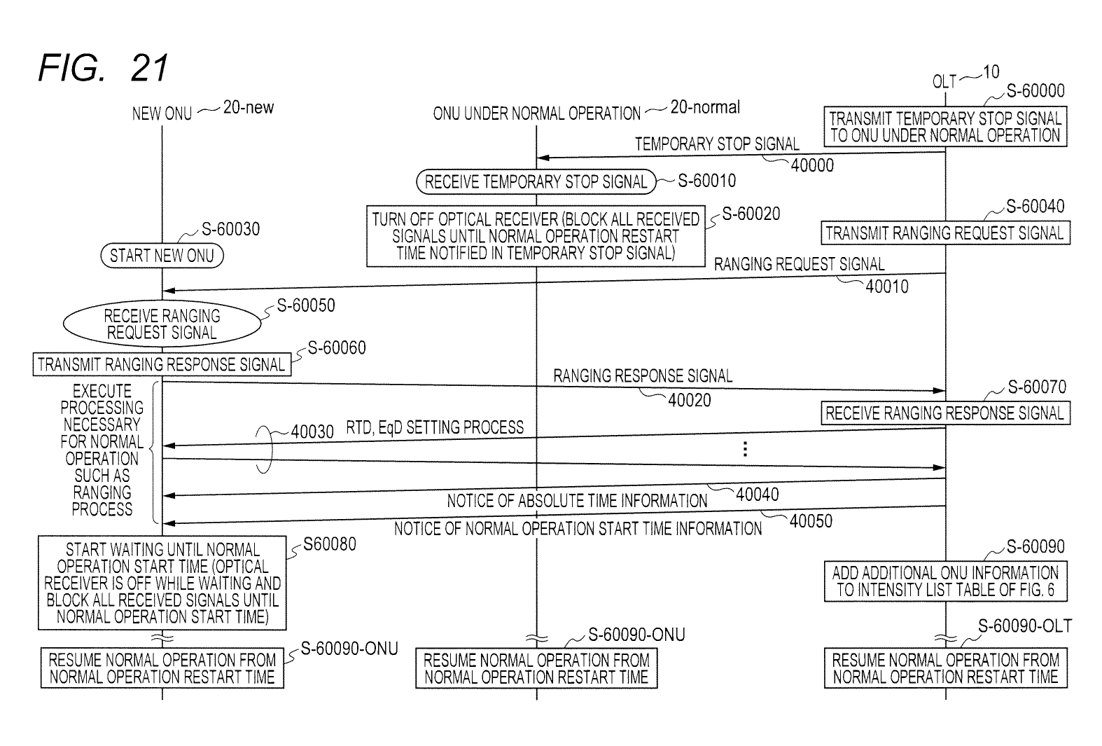

Next, with reference to FIG. 21, a procedure for registering a new ONU in the PON system 1 during the normal operation will be explained. Here, each of all the ONUS in the normal operation is assumed as ONU 20-normal, and the ONU to be newly registered is assumed as ONU 20-new. Firstly, the OLT 10 transmits, to the ONU 20-normal, a temporary stop signal 40000 for suspending the normal operation (S-60000). The ONU 20-normal that has received the temporary stop signal 40000 reads a normal operation restart time within the signal, and controls the O/E processor 2310 to block all the received signals until the normal operation restart time (S-60010, S-60020). By receiving this temporary stop signal, it is possible to prevent erroneous receiving due to a difference in optical sensitivity and a crash or failure of the optical receiver of the ONU, which may occur in the processing prior to the normal operation such as ranging process that is performed on the ONU 20-new. It is further possible to avoid collision between the uplink signal such as a ranging response signal 40020, which the ONU 20-new will transmit later, and the uplink signal which the ONU 20-normal transmits during the normal operation. For example, the temporary stop signal 40000 may assign the normal operation restarting time, as the next signal receive start time, to the downlink intensity map within the normal downlink frame.

After transmitting the temporary stop signal 40000, a professional installer or a user who is informed that the startup is ready starts the ONU 20-new (S-60030). Subsequently, similarly to the starting operation as shown in FIG. 7 to FIG. 10, the OLT 10 transmits a ranging request signal 40010 to the ONU 20-new, while adjusting the optical intensity and the communication bit rate, and waits for the ranging response signal 40020 from the ONU 20-new (S-60040). On this occasion, if distance information of the installation site or the target ONU, the communication bit rate, and the like, are already known, it is further possible for an operator to give a directive to the OLT 10 to transmit the ranging request signal 40010 with designation of the optical intensity and the communication rate. The ONU 20-new which has received the ranging request signal 40010 (S-60050) transmits the ranging response signal 40020 to the OLT 10 (S-60060). The OLT 10 which has received the ranging response signal 40020 (S-60070) performs, with the ONU 20-new, the processes (40030, 40040, 40050) until the normal operation is started as described with reference to FIG. 7 to FIG. 10, at the optical intensity and the communication bit rate of the ranging request 40010 transmitted. Subsequently, the ONU 20-new controls the O/E processor 2310 to block all the received signals until the normal operation resume time and stands ready (S-60080). The details of the processes are the same as those described with reference to FIG. 7 to FIG. 10, and tedious explanation will not be made. On this occasion, the information of the ONU 20-new is added to the table information as shown in FIG. 12, and it is used for generating the downlink frame and the downlink intensity map subsequently performed (S-60090).

When the normal operation restart time comes, the OLT 10, the ONU 20-normal, and the ONU 20-new resumes the normal operation (S-60100-OLT, S-60100-0NU).

What is claimed is:

1. A passive optical network system comprising:
a plurality of subscriber units; and
a subscriber line terminal that is connected to the subscriber units via an optical fiber,
wherein the subscriber line terminal includes
means for measuring a communication distance from each of the subscriber units and holding a result of distance measurement;
means for adjusting optical intensity of a signal to be communicated to the subscriber unit, according to the result of the distance measurement;
means for providing a notice as to an optical signal transmission plan addressed to the subscriber unit, prior to a time for outputting an optical signal addressed to the subscriber unit; and
means for generating the optical signal addressed to the subscriber unit and the optical signal transmission plan, using, as criteria, whether or not information to be transmitted to the subscriber unit exists, an amount of the information waiting to be transferred, and at least one of urgency, priority, and arrival sequence of the information, and
the subscriber unit includes:
means for identifying, out of optical signals transmitted from the subscriber line terminal, an optical signal having optical intensity receivable by the subscriber unit itself or an optical signal addressed to the subscriber unit itself; and
means for receiving only the optical signal having the optical intensity receivable by the subscriber unit itself or the optical signal addressed to the subscriber unit itself, and blocking or discarding other optical signals.

2. The passive optical network system according to claim 1,
wherein the subscriber line terminal further includes an optical intensity adjustment circuit for setting transmitted optical intensity in order to adjust optical signal intensity for downlink communication, according to a connection distance from the subscriber unit, and
the subscriber line terminal uses the optical intensity adjustment circuit to set optimum optical signal intensity for transmitting the optical signal to the subscriber unit as a destination, based on the result of the distance measurement.

3. The passive optical network system according to claim 1,
wherein the subscriber unit further includes means for determining the optical signal intensity receivable by the subscriber unit itself, so as to receive a downlink optical signal transmitted from the subscriber line terminal.

4. The passive optical network system according to claim 2,
wherein the subscriber unit further includes means for determining the optical signal intensity receivable by the subscriber unit itself, so as to receive a downlink optical signal transmitted from the subscriber line terminal.

5. The passive optical network system according to claim 1,
wherein the subscriber line terminal accommodates a plurality of the subscriber units having different communication bit rates.

6. The passive optical network system according to claim 2,
wherein the subscriber line terminal accommodates a plurality of the subscriber units having different communication bit rates.

7. The passive optical network system according to claim 3,
wherein the subscriber line terminal accommodates a plurality of the subscriber units having different communication bit rates.

8. The passive optical network system according to claim 4,
wherein the subscriber line terminal accommodates a plurality of the subscriber units having different communication bit rates.

9. A subscriber line terminal connected with a plurality of subscriber units via an optical fiber, comprising:
means for measuring a communication distance from each of the subscriber units and holding a result of distance measurement; and
means for adjusting optical intensity of a signal to be communicated to the subscriber unit, according to the result of the distance measurement.

10. The subscriber line terminal according to claim 9, further comprising an optical intensity adjustment circuit for adjusting optical signal intensity for downlink communication, according to a connection distance from the subscriber unit,
wherein the optical intensity adjustment circuit sets optimum optical signal intensity for transmitting an optical signal to the subscriber unit as a destination, based on the result of the distance measurement.

11. The subscriber line terminal according to claim 9,
wherein when accommodating a plurality of the subscriber units, the subscriber units placed within a certain range at a predetermined connection distance from the subscriber line terminal are categorized in one group of the subscriber units, and in operating the subscriber units, the optical signal intensity for downlink communication is determined on a group basis of the subscriber units.

12. The subscriber line terminal according to claim 10,
wherein when accommodating a plurality of the subscriber units, the subscriber units placed within a certain range at a predetermined connection distance from the subscriber line terminal are categorized in one group of the subscriber units, and in operating the subscriber units, the optical signal intensity for downlink communication is determined on a group basis of the subscriber units.

13. The subscriber line terminal according to claim 9, for accommodating a plurality of the subscriber units having different communication bit rates.

14. The subscriber line terminal according to claim 10, for accommodating a plurality of the subscriber units having different communication bit rates.

15. The subscriber line terminal according to claim 11, for accommodating a plurality of the subscriber units having different communication bit rates.

16. The subscriber line terminal according to claim 12, for accommodating a plurality of the subscriber units having different communication bit rates.

17. The subscriber line terminal according to claim 9, for determining transmission plan information of a signal in the downlink communication, according to a result of monitoring a buffer provided in the subscriber line terminal itself, and notifying the subscriber units of the information at a relative time or at an absolute time.

18. The subscriber line terminal according to claim 10, for determining transmission plan information of a signal in the downlink communication, according to a result of monitoring a buffer provided in the subscriber line terminal itself, and notifying the subscriber units of the information at a relative time or at an absolute time.

19. The subscriber line terminal according to claim 11, for determining transmission plan information of a signal in the downlink communication, according to a result of monitoring a buffer provided in the subscriber line terminal itself, and notifying the subscriber units of the information at a relative time or at an absolute time.

20. The subscriber line terminal according to claim 12, for determining transmission plan information of a signal in the downlink communication, according to a result of monitoring a buffer provided in the subscriber line terminal itself, and notifying the subscriber units of the information at a relative time or at an absolute time.
